(19) United States
(12) Patent Application Publication
(10) Pub. No.: US 2016/0255846 A1
(43) Pub. Date: Sep. 8, 2016

(54) PATTY-FORMING APPARATUS WITH BOTTOM FEED AND BOTTOM FILL PLUNGER

(71) Applicant: Provisur Technologies, Inc., Chicago, IL (US)

(72) Inventors: Scott A. Lindee, Mokena, IL (US); Paul R. Taylor, Mokena, IL (US); Christopher Moore, Mokena, IL (US); E. William Wight, Mokena, IL (US); Thomas C. Wolcott, Mokena, IL (US); James E. Pasek, Mokena, IL (US)

(21) Appl. No.: 15/060,831

(22) Filed: Mar. 4, 2016

Related U.S. Application Data
(60) Provisional application No. 62/128,750, filed on Mar. 5, 2015.

(51) Int. Cl. A22C 7/00

(52) U.S. Cl. CPC A22C 7/0084; A23P 1/105

(57) ABSTRACT

A food product forming machine is provided. In one aspect, the food product forming machine includes a manifold including a manifold inlet and an outlet passageway, and a plunger channel positioned below the manifold. The plunger channel opens into a bottom of the manifold and is in fluid communication with the manifold. The food product forming machine also includes a fill plunger positioned below the manifold and the fill plunger is configured to reciprocate, at least partially within the plunger channel, between a retracted position and an extended position. In one aspect, the food product forming machine may include two plunger channels positioned below the manifold and two fill plungers configured to reciprocate, at least partially, within respect plunger channels.

### RELATED APPLICATIONS

The present application claims the priority benefit of co-pending U.S. Provisional Patent Application Ser. No. 62/128,750, filed Mar. 5, 2015, which is incorporated by reference herein.

### FIELD OF THE INVENTION

The present disclosure generally relates to forming food products and, more particularly to a food product forming machine for forming food product.

### BACKGROUND

Increasing use of pre-processed foods, both in homes and in restaurants, has created a continuously growing demand for high-capacity automated food processing equipment. That demand is particularly evident with respect to hamburgers, molded steaks, fish cakes, and other molded food patties.

Food processors utilize high-speed molding machines, such as FORMAX® MAXUM700®, F-6™, F-12™, F-19™, F-26™, or F-400™ reciprocating mold plate forming machine, available from Formax, Inc. of Mokena, Ill., U.S.A., for supplying patties to the fast food industry. High-speed molding machines are also described for example in U.S. Pat. Nos. 3,887,964; 4,372,008; 4,356,595; 4,821,376; 4,996,743, and 7,255,554.

Although heretofore known FORMAX patty-molding machines have achieved commercial success and wide industry acceptance, the present inventors have recognized that needs exist for a forming machine having an even greater energy efficiency, an even greater durability; and an even greater duration of maintenance free operation. The present inventors have recognized that needs exist for an enhanced controllability and ability to tune a patty-forming machine for particular food materials to be processed, for an enhanced effectiveness of a patty-forming machine in producing uniform patties, for an even greater output rate of patties from a patty-forming machine, for an enhanced convenience for cleaning and maintenance of a patty-forming machine, and for a smoother and quieter patty-forming machine operation.

Protective headwear typically includes headgear within the headwear to engage a wearer's head and support the protective headwear upon the wearer's head. Conventional headgear is uncomfortable, unstable on a wearer's head, and poor at accommodating different size heads.

### SUMMARY

In one aspect, the food product forming machine of the present disclosure provides an automated food product molding machine capable of producing uniform molded food products, such as food patties, at a high rate of production.

In one aspect, the food product machine has a food supply, a rotary food pump connected to the food supply, a molding mechanism having a mold plate and a knockout drive, the mold plate configured to be driven to reciprocate between a fill position and a discharge position. The knockout drive is for reciprocating a knockout plunger to discharge molded food products from a cavity in the mold plate, the mold plate being reciprocated by a mold plate drive between a cavity fill position and a cavity discharge position. The machine further includes a manifold connected an outlet of the food pump and having an outlet passageway connected to an inlet of the molding mechanism for filling the cavity of the mold plate.

In one aspect, the food pump is a positive displacement pump. The pump has two rotors configured to create a vacuum between the inlet and the outlet when driven to rotate for drawing food product to the outlet.

In one aspect, the rotary food pump has two rotors. Each rotor has at least two wings and each rotor has an area of rotation that overlaps with that of the other rotor. The pump has a drive shaft and a driven shaft, the drive shaft has a drive gear at a first end and one of the rotors at the second end, the driven shaft has a driven gear at a first end and the other of the rotors at the second end; the drive and driven gears are meshed to operate the rotors in sync.

In one aspect, the machine has a pump motor connected to a drive shaft of the rotary pump. The pump motor is a servo rotary actuator.

In one aspect, the machine has a hopper for holding a supply of food product, and an auger system configured to force food product through an outlet of the hopper. The auger system has one feed screw configured to move food product longitudinally forward in the hopper toward the outlet.

In one aspect, the feed screw is located in the hopper connected to a feed screw drive configured to rotate the feed screw. The feed screw is located at the bottom of the hopper. The feed screw is positioned horizontally in the bottom of the hopper and is configured to rotate and drive food product toward the front of the hopper.

In one aspect, the hopper has an outlet at the front of the hopper. The outlet extends from the floor of the hopper upward at the front of the hopper.

In one aspect, the outlet that extends forward of the main hopper body encloses a forward portion of the feed screw. The outlet has a connecting section connected to the main hopper body, and a narrowing section opposite the connecting section.

In one aspect, the hopper has an opening at the lower rear of the hopper configured to remove the feed screw therethrough for maintenance, and a cap for removably covering the opening; the feed screw journaled to rotate in an opening of the cap.

In one aspect, the feed screw drive is located outside of the hopper and is axially aligned and connected with a shaft of the feedscrew. The feed screw is longitudinally orientated at the bottom of the hopper.

In one aspect, the auger system has a plurality of feed screws located in the hopper. The feed screws are located adjacent to each other and adjacent to the floor of the hopper.

In one aspect, a food product forming machine is provided and includes a food supply, a rotary food pump in communication with the food supply and including a pump outlet, a molding mechanism having a mold plate with a mold cavity, the mold plate configured to be reciprocated by a mold plate drive between a cavity fill position and a cavity discharge position, a knockout drive configured to reciprocate a knockout plunger to discharge molded food products from the mold cavity in the mold plate, a manifold including a manifold inlet and an outlet passageway, wherein the manifold inlet is in communication with the outlet of the food pump and the outlet passageway is in communication with an inlet of the molding mechanism for filling the mold cavity of the mold plate, and a fill plunger positioned below the manifold and configured to reciprocate between a retracted position and an extended position.

In one aspect, the fill plunger may be a first fill plunger, the food product forming machine may further include a second fill plunger positioned below the manifold and configured to reciprocate between a retracted position and an extended position.

In one aspect, the first and second fill plungers may move together in synchronization between the retracted and extended positions.

In one aspect, the food product forming machine may further include a lower housing positioned below the manifold. A plunger channel may be defined in the lower housing and configured to receive the fill plunger therein.

In one aspect, the fill plunger may be hydraulically driven between the retracted and extended positions.

In one aspect, the plunger channel may open into a bottom of the manifold.

In one aspect, the fill plunger may be a first fill plunger and the plunger channel may be a first plunger channel. The food product forming machine may further include a second fill plunger and a second plunger channel. The second fill plunger may be positioned below the manifold and configured to reciprocate between a retracted position and an extended position and the second plunger channel may be defined in the lower housing and configured to receive the second fill plunger therein. The second plunger channel may open into the bottom of the manifold.

In one aspect, the first and second fill plungers may be hydraulically driven between the retracted and extended positions.

In one aspect, the manifold inlet may be positioned at a bottom of the manifold.

In one aspect, a food product forming machine is provided and includes a manifold including a manifold inlet and an outlet passageway. The food product forming machine also includes a plunger channel positioned below the manifold and the plunger channel opens into a bottom of the manifold and is in fluid communication with the manifold, and a fill plunger positioned below the manifold and the fill plunger is configured to reciprocate, at least partially within the plunger channel, between a retracted position and an extended position.

In one aspect, the plunger channel may be a first plunger channel and the fill plunger may be a first fill plunger, the food product forming machine may further include a second plunger channel positioned below the manifold and the second plunger channel may open into the bottom of the manifold and may be in fluid communication with the manifold, and a second fill plunger may be positioned below the manifold. The second fill plunger may be configured to reciprocate, at least partially within the second plunger channel, between a retracted position and an extended position.

In one aspect, the first and second fill plungers may move together in synchronization between the retracted and extended positions.

In one aspect, the first and second fill plungers may be hydraulically driven between the retracted and extended positions.

In one aspect, the food product forming machine may further include a lower housing positioned below the manifold and the first and second plunger channels may be defined in the lower housing.

In one aspect, the food product forming machine may further include a lower housing positioned below the manifold and the plunger channel may be defined in the lower housing.

In one aspect, the fill plunger may be hydraulically driven between the retracted and extended positions.

In one aspect, the manifold inlet may be positioned at a bottom of the manifold.

Numerous other advantages and features of the present disclosure will become readily apparent from the following detailed description of the present disclosure and the examples thereof, from the claims and from the accompanying drawings.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 is a side view of the food product forming machine of the present disclosure.

FIG. 2 is an enlarged partial side view a rotary pump and molding mechanism of the food product forming machine taken from FIG. 1.

FIG. 3 is a partial top view of a portion of the food supply system, the rotor pump and the molding mechanism of the forming machine shown in FIG. 1.

FIG. 4 is a top view of the forming machine of FIG. 1.

FIG. 5 is a partial side view of the food supply system and a mold plate drive system of the forming machine.

FIG. 6 is a partial top view of a portion of the hopper and feed screw drive of the forming machine.

FIG. 7 is a rear view of the forming machine of FIG. 1.

FIG. 8 a partial rear view of the forming machine taken from FIG. 7.

FIG. 9 is a side view of a portion of the molding mechanism.

FIG. 10 is a side view of a portion of the molding mechanism.

FIG. 11 is a front view of a knockout mechanism.

FIG. 12 is a front view of a portion of the knockout mechanism.

FIG. 13 is a font view of the forming machine of FIG. 1.

FIG. 14A is an inlet side view of the rotary food pump.

FIG. 14B is an outlet side view of the rotary food pump.

FIG. 14C is a perspective view of a rotor from the rotary food pump.

FIG. 14D is a top side view of the rotary food pump.

FIG. 14E is a schematic diagram of a portion of the rotary pump.

FIG. 14F is a wing of the rotor with a portion of it in an area of operation.

FIG. 15 is a top side view of the rotary pump with the face plate removed.

FIG. 16 is a bottom side view of the rotary pump with the back plate removed.

FIG. 17 is a perspective view of a rotary pump motor.

FIG. 18 is a side view of a fill plunger in a depressed, extended or lowered position.

FIG. 19 is a side view of the fill plunger in a raised or retracted position.

FIG. 20 is a front view of the fill plunger system.

FIG. 21 is a top view of the fill plunger drive system.

FIG. 22 is a front view of the fill plunger drive system.

FIG. 23 is a top perspective view of a food product forming machine of the present disclosure.

FIG. 24 is another top perspective view of the food product forming machine of FIG. 23.

FIG. 25 is a cross-sectional view taken along line 25-25 in FIG. 23 showing a fill plunger in a retracted or lowered position.

FIG. 26 is an enlarged side view of the fill plunger in the retracted or lowered position.

FIG. 27 is an enlarged side view of the fill plunger in a depressed, extended or raised position.

FIG. 28 is a cross-sectional view taken along line 28-28 in FIG. 25 showing fill plungers in the retracted or lowered position.

FIG. 29 is a cross-sectional view similar to the cross-section view in FIG. 28 showing the fill plungers in the depressed, extended or raised position.

FIG. 30 is a top perspective view of one example of a seal associated with the fill plungers.

### DETAILED DESCRIPTION

While the present disclosure is susceptible of examples in many different forms, there are shown in the drawings, and will be described herein in detail, specific examples thereof with the understanding that the present disclosure is to be considered as an exemplification of the principles of the present disclosure and is not intended to limit the present disclosure to the specific examples illustrated.

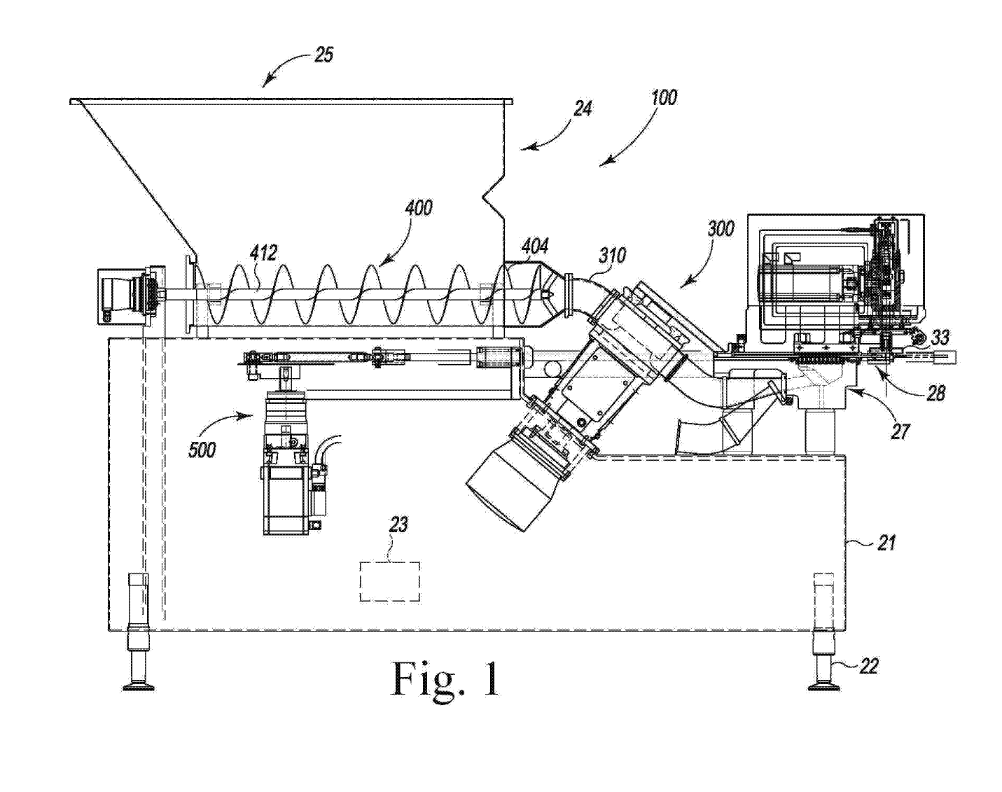

The food product forming machine or food patty molding machine 100 is illustrated in FIGS. 1-13. The molding machine 100 includes a machine base 21, optionally mounted upon a plurality of feet 22, rollers or wheels. The machine base 21 supports the operating mechanism for machine 100 and contains electrical actuating systems, and most of the machine controls. The machine 100 includes a food supply system 24 for supplying moldable food material, such as ground beef, fish, or the like, to the processing mechanisms of the machine. A control panel, such as a touch screen control panel 601, is arranged on a forward end of the machine 100.

As generally illustrated in FIGS. 1-8, the food supply system includes an auger system 400 and a hopper 25 that opens into the intake of a food pump system 300. The food pump system 300 includes at least one food pump, described in detail hereinafter, that continuously, or intermittently under a pre-selected control scheme controlled by a machine control 23, pump food, under pressure, into a manifold 27 flow-connected to a cyclically operated molding mechanism 28. Generally during operation of the machine 100, the pump is forcing food material under pressure into the intake of manifold 27. The operation of the machine is controlled by the machine control 23.

In the operation of machine 100, a supply of ground beef or other moldable food material is deposited into hopper 25 from overhead. An automated refill device (not shown) can be used to refill the hopper when the supply of food product therein is depleted. At the bottom of the hopper 25 is the auger system 400 for moving the food material longitudinally along the hopper 25 to the inlet 301 of the food pump system 300.

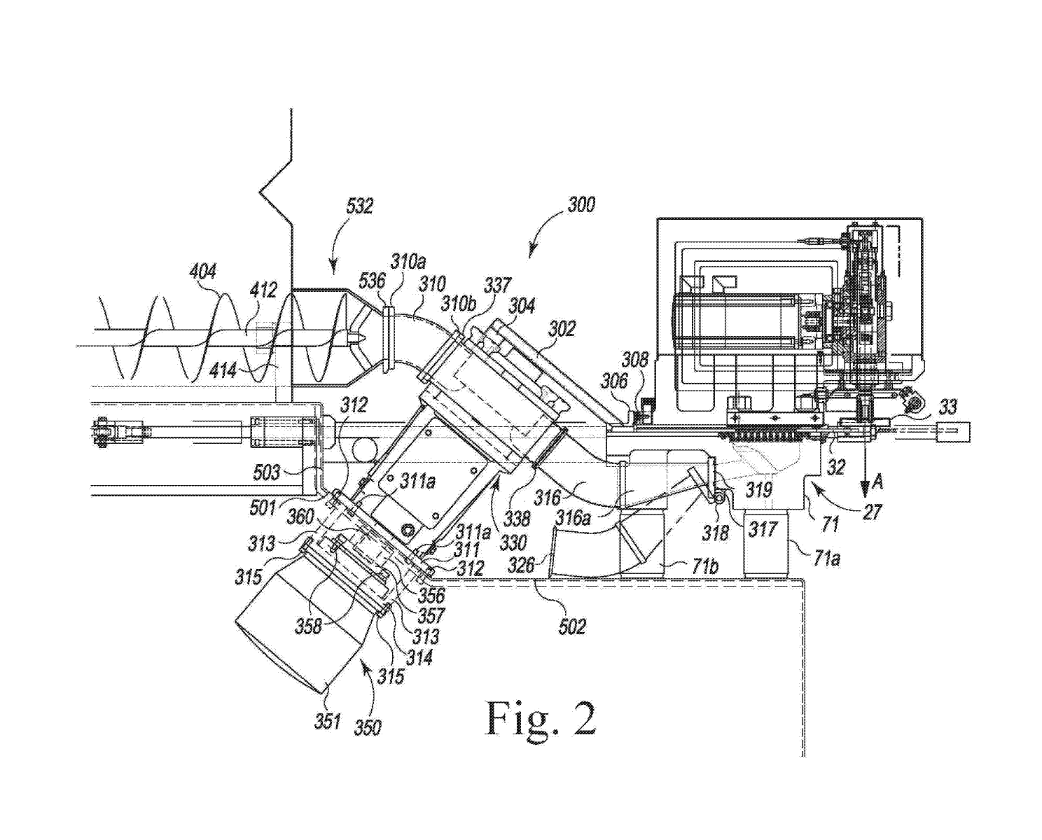

The manifold 27 comprises a system for feeding the food material, still under relatively high pressure, into the molding mechanism 28. Molding mechanism 28 operates on a cyclic basis, first sliding a multi-cavity mold plate 32 into a receiving position over manifold 27 and then away from the manifold to a discharge position aligned with a series of knock out cups 33. When the mold plate 32 is at its discharge position, knock out cups 33 are driven downwardly, discharging hamburgers or other molded patties from machine 100, as indicated by direction A in FIG. 2. The molded patties are deposited onto a conveyor (not shown) that is positioned under the knockout cups 33, to be transported away from the machine 100.

The food supply system 24 includes the hopper and the auger system 400, as shown in FIGS. 1-8. The auger system 400 is located at the bottom of the hopper 25. The auger system includes two feed screws 402, 404, and two feed screw drive motors 406, 408. The feed screws 402, 404 each have a center shaft 410, 412. The center shaft is journaled in and supported by front and rear feed screw supports 414, 422. The feed screw supports extend vertically from and attach to the machine base 21. The feed screws are located adjacent to one another and extend longitudinally along the bottom of the hopper. The center shafts are parallel to the bottom 527 of the hopper.

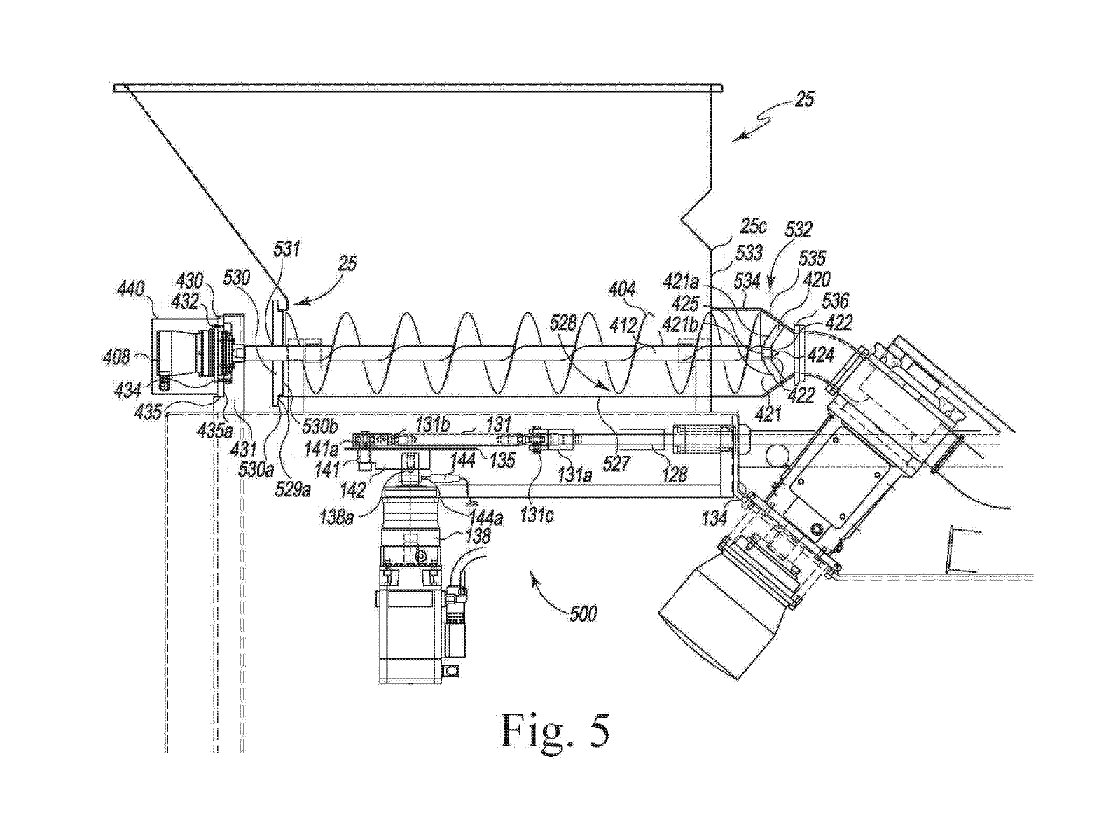

As shown in FIG. 5, the rear 25c of the hopper has an opening that is covered by a cap 530. The cap 530 has holes 531 that the feed screw shafts are journaled to rotate therein on bearings. The shafts extend through the cap to connect to the motors 406, 408. The rear opening of the hopper has a vertical lip 529a. The back of the cap has a recessed portion 530a that mates with the lip 529a. The cap also has a non-recessed portion 530b that fits into the rear opening.

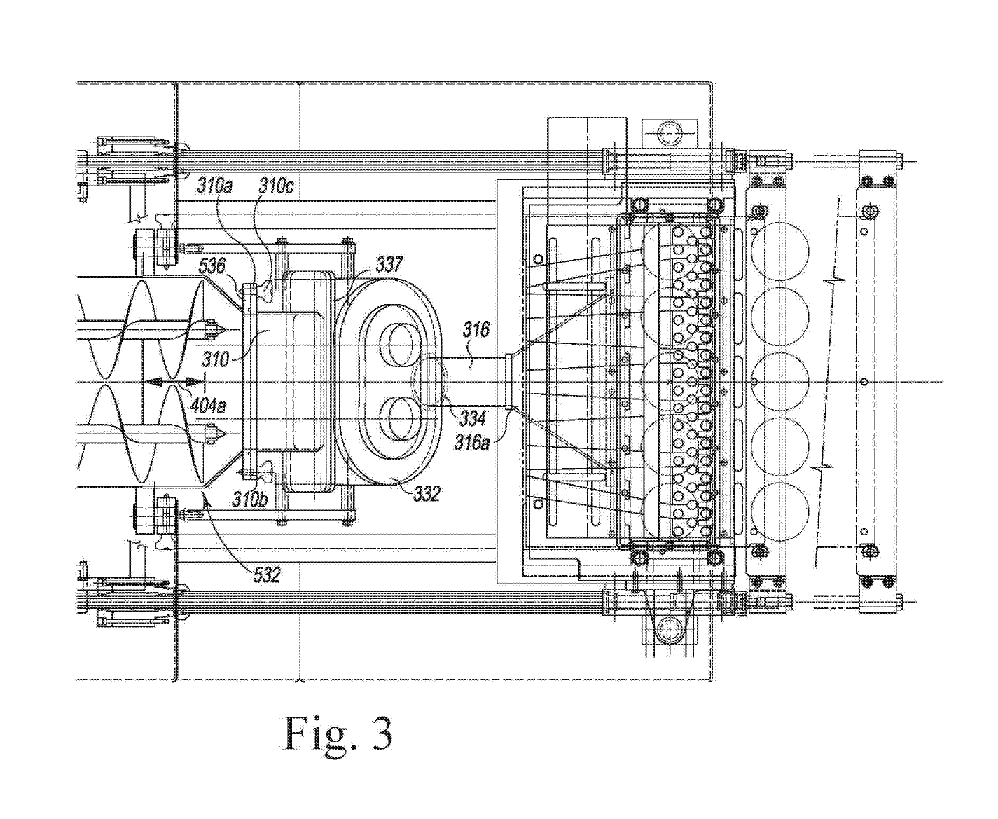

A hopper outlet 532 is formed to or attached to the front 533 of the hopper 25. A portion of the outlet opening is aligned with the bottom floor 527 of the hopper and the opening extends upwardly from the floor 527. The outlet extend forward of the main hopper body 25c as shown in FIG. 5. The outlet has a connecting section 534 and a narrowing section 535 that narrows to an outlet flange 536 toward the food pump system 300. The outlet has a width that is greater than its height. Upper and lower feed screw supports 420, 421 extend from the conical section 535 to a bearing head 422. The supports 420, 421 are perpendicular to the conical section 535 inside surface and extend therefrom to an elbow 421a, 421b and bearing sleeves 422. The front of the shafts 412, 410 have a recessed portion 425 that terminates in a conically reducing point end 424. The point end 424 extends beyond the bearing sleeves 422. The shafts 410, 412 are journaled to rotate at the front on the recessed portion 425 in the bearing sleeves. As shown in FIG. 3, a front portion 404a of each feed screws is enclosed by the outlet and extend beyond the main hopper body 25c.

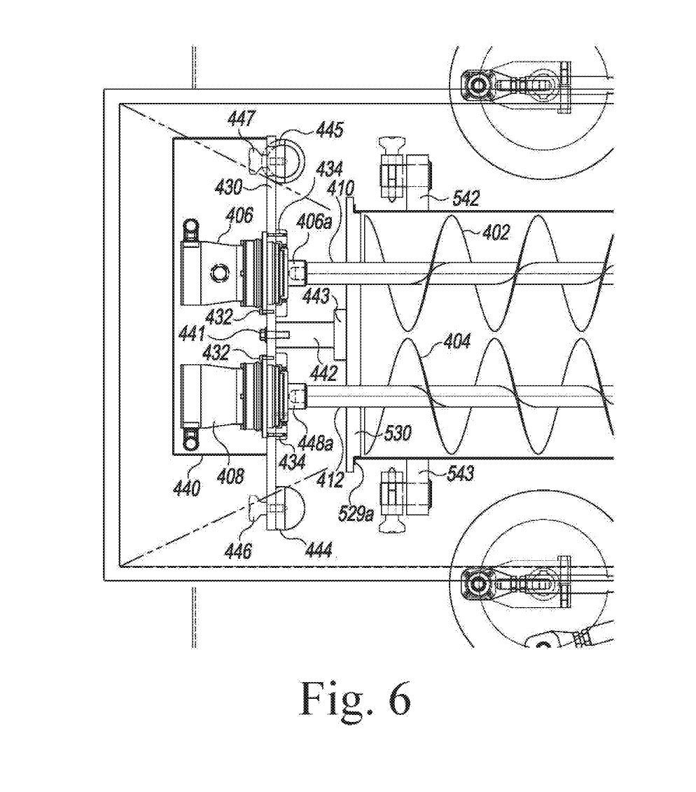

As shown in detail in FIGS. 5 and 6, the feed screw drive motors 406, 408 are mounted to a feed screw drive motor support plate 430 by screws, studs, or bolts 432. The support plate 430 is attached to a support mount 431 by screws or bolts 434. The support mount 431 is attached to vertical support members 444, 445 by fasteners 446, 447 respectively. The vertical support members 444, 445 extends vertically from the machine base 21 and is supported thereon. The support mount 431 has a ledge 435 defining a recessed area 435a. The support plate is located in the recessed area 435a and on the ledge 435. The drive motors, 406, 408 are enclosed by a drive motor housing 440. The drive motor housing 440 is attached to the support plate 430. The motors 406, 408 are axially aligned with the corresponding feed screws 402, 404 respectively. Output shafts 406a, 408a are coaxial with the corresponding feed screw shafts 410, 412 respectively. The supports hold the feed screw slightly above the bottom 527 surface of the hopper 25 to form a gap 528 between the feed screw and the bottom.

A cap retaining brace 442 is attached by a bolt 441 to the support plate 430 and extends forward to contact the cap 530 by a wide member base 443 to hold the cap engaged with the hopper 25.

The feed screws 402, 404 are removable from the hopper for service and cleaning. To remove the feed screws 402, 404, the support plate 430 and the support mount 431 disconnected from the vertical support members 444, 445 via the fasteners 446, 447. The support mount 431 is moved longitudinally rearward and the recessed portions 425 of the feed screw shaft are withdrawn from the bearing sleeves 422 at the front and the feed screws are withdrawn rearward from the hopper.

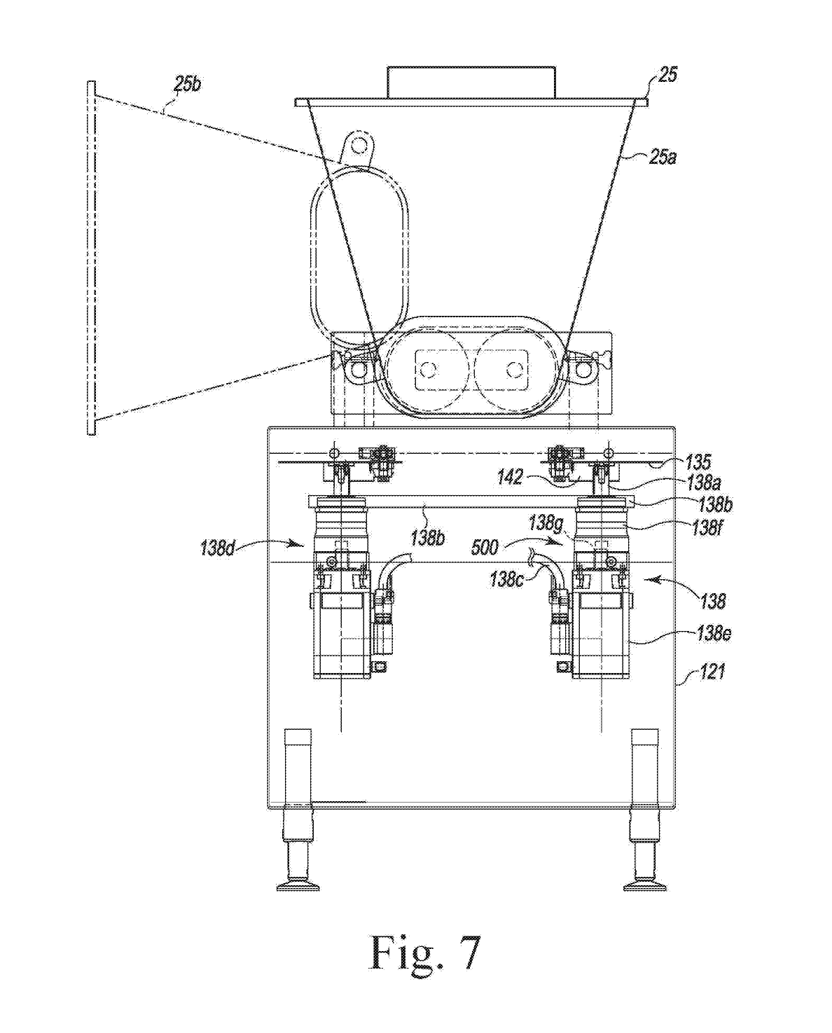

The hopper is shown in FIGS. 1, 4, 5, 7, and 8. As shown in FIG. 7, the hopper 25 has a working position 25a and a service position 25b. When the hopper is in the service position it is tilted 90 degrees to the right or left side to permit a person to more easily clean or service the hopper.

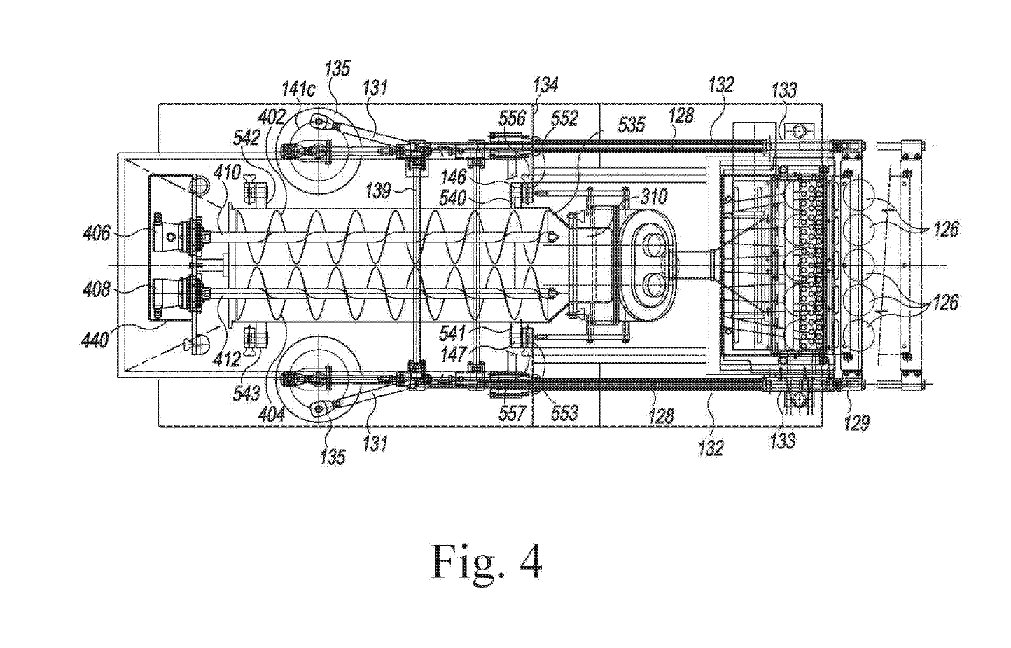

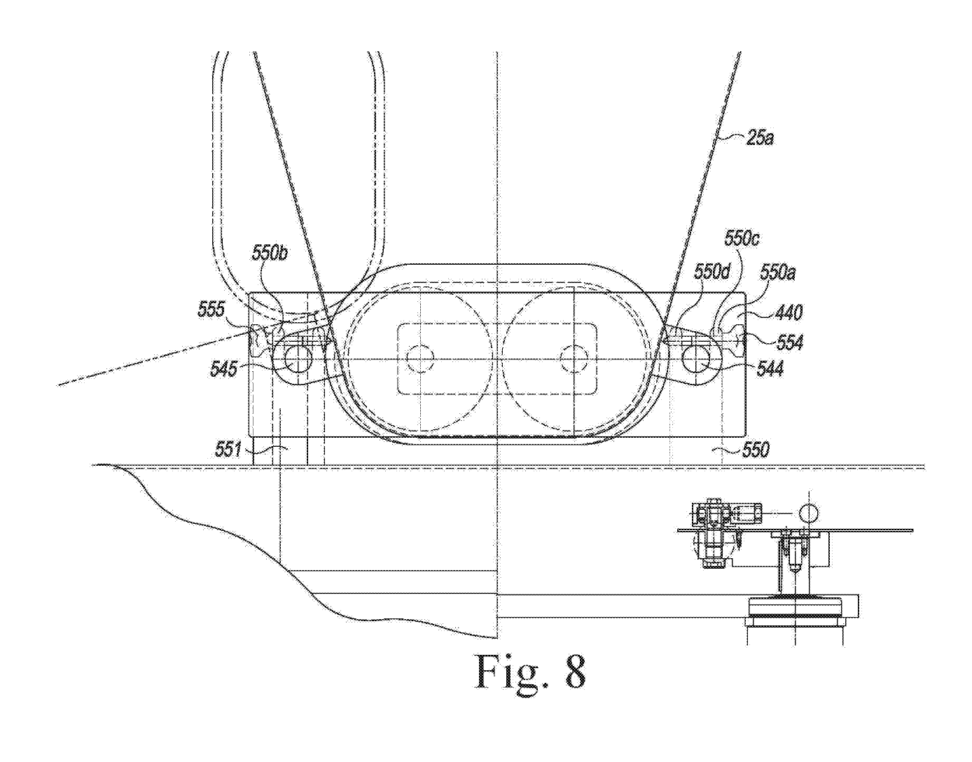

As shown in FIG. 4A, the hopper 25 has front and rear pairs of mounting arms 540, 541, 542, 543. Each mounting arm has a horizontal support pin 544, 545, 546, and 547. The front mounting pins extend forwardly from the front mounting arms 540, 541 and the rear mounting pins extend rearward from the rear mounting arms 542, 543. The pins engage a hopper support 550, 551, 552, 553. Each hopper support, as best shown in FIG. 8, has a U-shaped end 550a, 550b (not labeled for front hopper supports). The outer end of each pin lies in the U-shaped channel of the U-shaped end. Each U-shaped end has a part of co-linear holes 550c, 550d (labeled only for support 150) penetrating an upper portion of the U-shaped end. The co-linear holes are located above the area that the pin would occupy in the U-shaped channel. Retaining pins are removably placed through the co-linear holes when the support pin is in the U-shaped channel to secure the hopper to the hopper supports.

To move the hopper from the working position to the service position, each of the retaining pins on one lateral side of the machine are removed and the hopper is tilted to the service position in the direction opposite of the lateral side where the retaining pins were removed. The hopper pivots toward the side were the retaining pins remain in place and the hopper pivots on the support pins. Likewise to move the hopper to the working position from the service position, the hopper is tilted toward the side of the machine where the retaining pins were removed, until the support pins on that side engage the U-shaped supports. Then the retaining pins are secured through the co-linear holes to secure the hopper in the working position.

The food pump system 300 of the machine 100 is shown in FIGS. 1, 2, 3, 4, and 14A-17. The pump system 300 comprises a rotary pump 330, a pump motor 350, a mounting bracket 302, a pump intake passage 310, and a pump output passage 316.

The outlet flange 536 of the hopper outlet 532 connects to a first flange 310a of the pump intake passage 310. A gasket may be provided between the outlet flange 536 and the first flange 310a to seal the connection therebetween. The intake passage 310 has a second flange 310b at an end opposite the first flange 310a. The second flange 310b connects to the pump intake flange 337 which surrounding the intake opening 334 of the food pump 330. A gasket 336 may be provided between the outlet flange 536 and the first flange 310a to seal the connection therebetween. The intake flange is located at a vertical position that is higher than the vertical position of the mold plate and manifold 27.

The pump 300 is mounted and supported by an upper brace 302 and an angled wall 501 of the machine base 21. The machine base 21 has a vertical wall 503 connecting to the angled wall 501 that angles downward and toward the molding mechanism 28. The angled wall connects to a lower horizontal wall 502. In one example, the pump is mounted and orientated in a plane that is substantially parallel or co-planar to the angled wall 501. The pump has an inlet that is located above the mold plate and the manifold 27. The pump has an outlet that is located below the mold plate and the manifold 27. The pump may be angled on a slant between the location of the inlet and the location of the outlet.

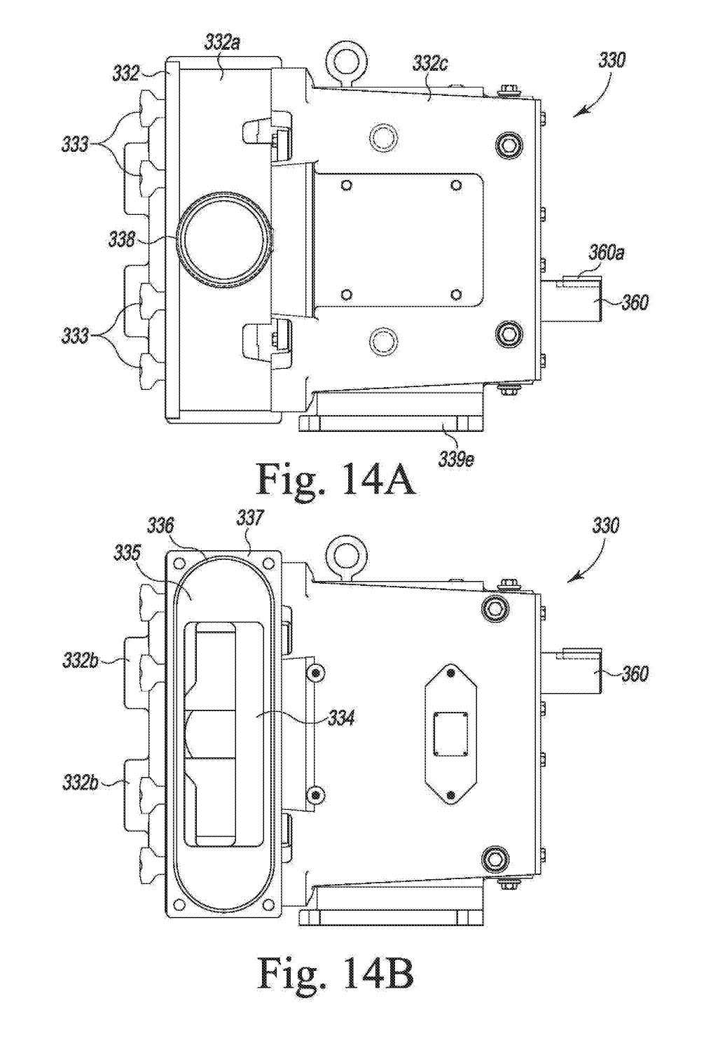

The rotary pump is shown in detail in FIGS. 14A-16. In one example, the pump rotary pump is a Universal I Series Positive Displacement Rotary Pump, model number 224-UI with a rectangular outlet flange manufactured by Waukesha Cherry-Burrell, with a place of business in Delavan, Wis., and affiliated with SPX Flow Technology. A positive displacement pump causes a food material to move by trapping a fixed amount of it then forcing that trapped volume into the discharge opening or pipe.

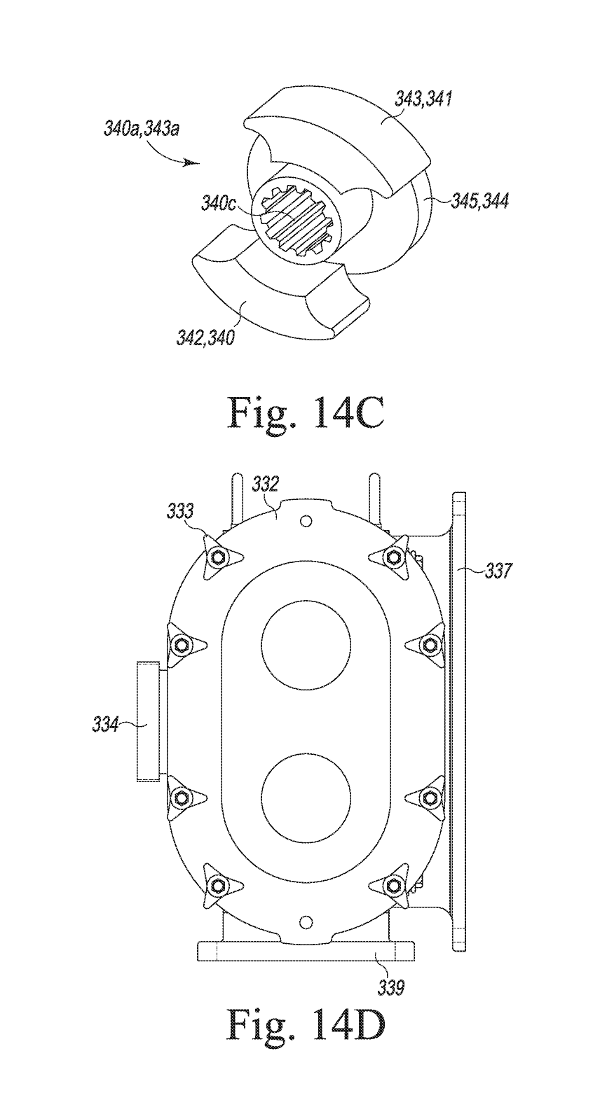

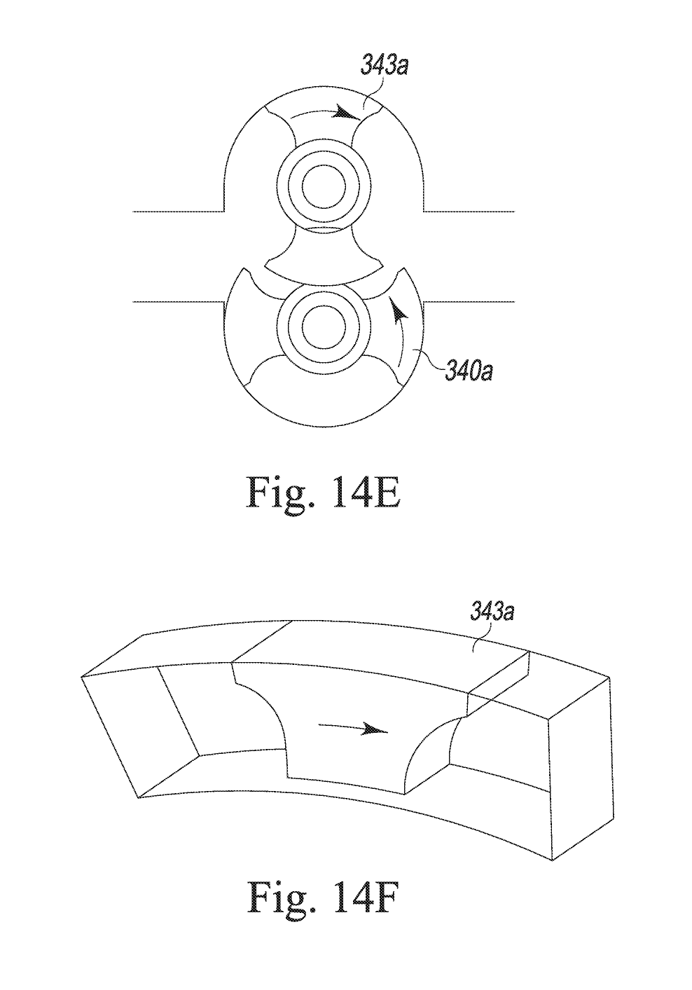

As shown in FIG. 15, the pump 330 has a housing with a pump area 332a and a gear area 332c. The pump has an inlet 334 and an outlet 338 in communication with the pump area 332a. The pump area is separated from the gear area by a wall 332d. A portion of the gear area is shown in FIG. 16 were the back cover plate is removed. A drive gear 364 and a driven gear 365 are meshed across a meshed arch of each gear 356a, 364a. The drive gear is keyed to rotate in sync with the drive shaft 360 at a first end of the drive shaft. The drive gear has a locking nut and lock washer 361 that assists in securing the gear to the drive shaft. The driven gear is keyed to rotate the driven shaft 363. The driven shaft has a locking nut and lock washer 361 that assists in securing the gear to the driven shaft at a first end of the drive shaft. The driven and drive shafts are journaled through a support structure (not shown) in the housing to carry rotors 340a, 343a at second ends of the driven and drive shafts opposite the first ends. The support structure (not shown) in the housing contains high capacity, double tapered roller bearings that the drive and driven shafts rotate on. The rear cover plate (not shown) contains an opening to allow the drive shaft to extend outside of the housing to engage a drive source such as the motor 350.

The second ends of the drive and driven shafts have a splined section (not shown). The rotors 340a 343a have a splined opening that mates with the splined section of the drive and driven shafts respectively. Each rotor 340a, 343a has two wings 340, 341 and 342, 343, respectively. The wings have overlapping areas of rotation as shown in FIG. 14E. Each wing is located opposite the other wing on the rotor and gaps are located between the wings about the circumference of the rotor. The wings travel in annular-shaped cylinders 339c (not labeled for rotor 340a) machined into the pump body. The rotor is placed on the shaft with a plate portion 344, 345 outwardly facing. Nuts 348, 349 are screwed on a threaded end portion of the shafts to secure the rotor in place. The rotors have a close fit clearance between the outer surface of the wing 343a and the corresponding cylinder wall faces 339c of the pump area. As shown in FIG. 14E, the wing of one rotor will be located in the open area of the other rotor during a portion of an operation cycle. An operation cycle comprises a full 360 degree rotation of a rotor.

The splined mating of the rotors and shafts ensure that the rotors rotate in sync with the respective drive and driven shafts. The rotors are interference fitted in the pump area as shown by their overlapping areas of rotation. The gearing 356a, 364a prevents the rotors from contacting each other during operation.

When the drive shaft 360 is rotated in direction C shown in FIG. 16, the drive shaft rotate the first rotor in the same direction, direction A in FIG. 15. Simultaneously, as provided by the meshed gearing 364, 365 the second rotor is rotated in the opposite direction, as shown by direction B in FIG. 15, of that of the first rotor.

The vacuum created by the rotation of the rotors 340a, 343a captures and draws food product in to an inlet 334, through the pump and the outlet passage 338a, and out the outlet 338. The outlet may have threads 338b on the outside of the outlet as shown in FIG. 15.

The pump area 332a face 339a is covered to enclose the pump area by a face plate 332. The face plate has raised areas 332b for accommodating space required for the shaft ends and the corresponding nuts 348, 349. The face has a plurality of holes corresponding to the studs 339 that extend from the face 339a. Face plate wing nuts 333 secure the face plate to the face 339a.

The outlet 338 is a circular outlet and the inlet 334 is an oblong with a rectangular flange 337. The rectangular flange 337 has an oval seal or gasket 336 surrounding the oblong inlet.

The outlet 338 connects pump output passage 316. The output passage 316 includes an expanding-V section 316a that connects with the manifold inlet passage 111. The output passage 316 connected to the manifold 27 with a lower hinge 318. When the output passage is connected to the rotary pump 330 and the output passage is in the deployed position, a flange 317 of the output passage is flush with the face 319 of the manifold at the inlet passage 111. When the output passage is disconnected from the rotary pump and in a lowered position 326, the flange and output passage pivots downward and away from the inlet passage about the lower hinge 318.

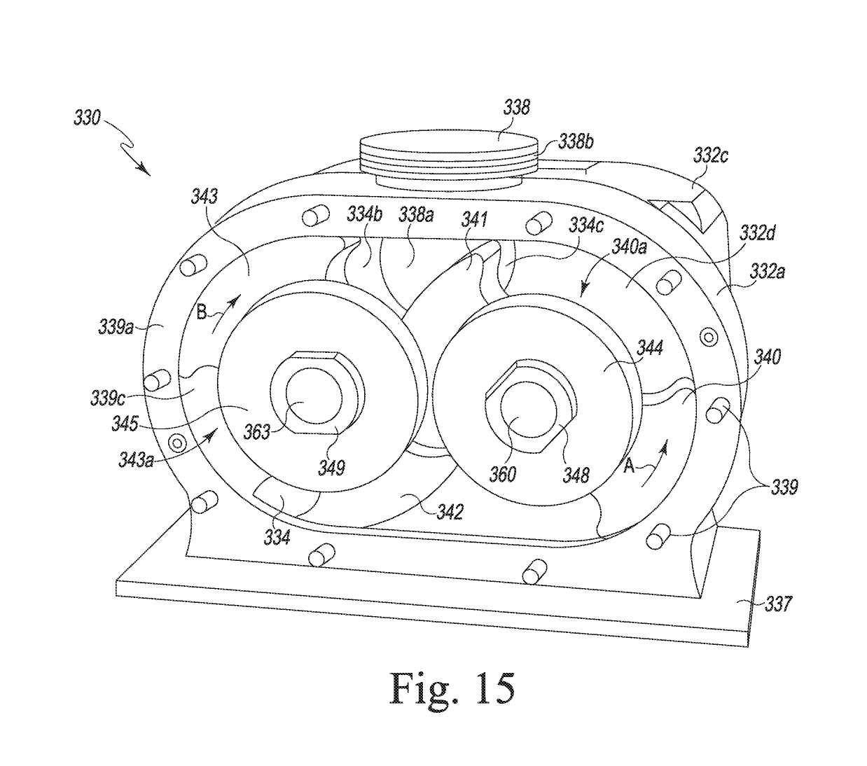

The pump 330 is driven by the pump motor 350. The motor is shown in FIG. 17. In one example, the motor 350 is a servo rotary actuator, such as the TPM+ Power 110 Stage 2 series rotary actuator with brake manufactured by Wittenstein, Inc. with a place of business in Bartlett, Ill. In one example motor 350 is an electric servo rotary actuator, such as the model TPMP110S manufactured by Wittenstein, Inc. The servo rotary actuator comprises a combined servo motor and gearbox assembly in one unit. The servo rotary actuator has a high-torque synchronous servo motor. The configuration of the servo motor and the gearbox gearing provides the actuator with a reduced length. The actuator has a helical-toothed precision planetary gearbox/gearhead for reduced noise and quiet operation. The rotary actuator has a 70:1 gearing ratio, 1180 ft./lbs. of torque, and maximum speed of 65 RPMs.

The motor 350 has a housing 351, an electrical connection 351b, a mounting face 315b, and an output coupling flange 358b. The mounting face 315b has a plurality of holes 315a. As shown in FIG. 2, the pump is secured to a mounting plate by a plurality of bolts 311a which engaged the back of the pump, such as by engaging threaded holes 332e at the back of the pump. The mounting plate is secured to the machine base 22 by bolts 312. A circular mounting member 313 encloses the connection between the motor and the pump and attaches to the mounting plate 311. Alternatively, the mounting member 313 may connect directly to the machine base. The mounting member 313 connects to the motor 350 at the mounting face. A number of bolts 315 secure the motor to the mounting member. A circular coupling 356 is attached to the output coupling flange 358b by bolts 358 threaded into the correspondingly threaded holes 358a of the output coupling flange 358b. At an opposite end, the coupling 356 receives the drive shaft 360 in an opening of the coupling 356. The drive shaft has a key 360a that engages a corresponding slot of the opening of the coupling 356 to lock the machine 100 to the drive shaft of the pump. The motor is angled to align with the output shaft of the pump.

In one example, a fill plunger system is disposed downstream of the pump to increase the pressure of the food mass within the manifold prior to, or simultaneously with, the filling of the mold cavities. The fill plunger system can be one similar to the fill plunger system described in U.S. Ser. No. 13/187,448, filed on Jul. 20, 2011, and herein incorporated by reference to the extent not inconsistent with the present disclosure.

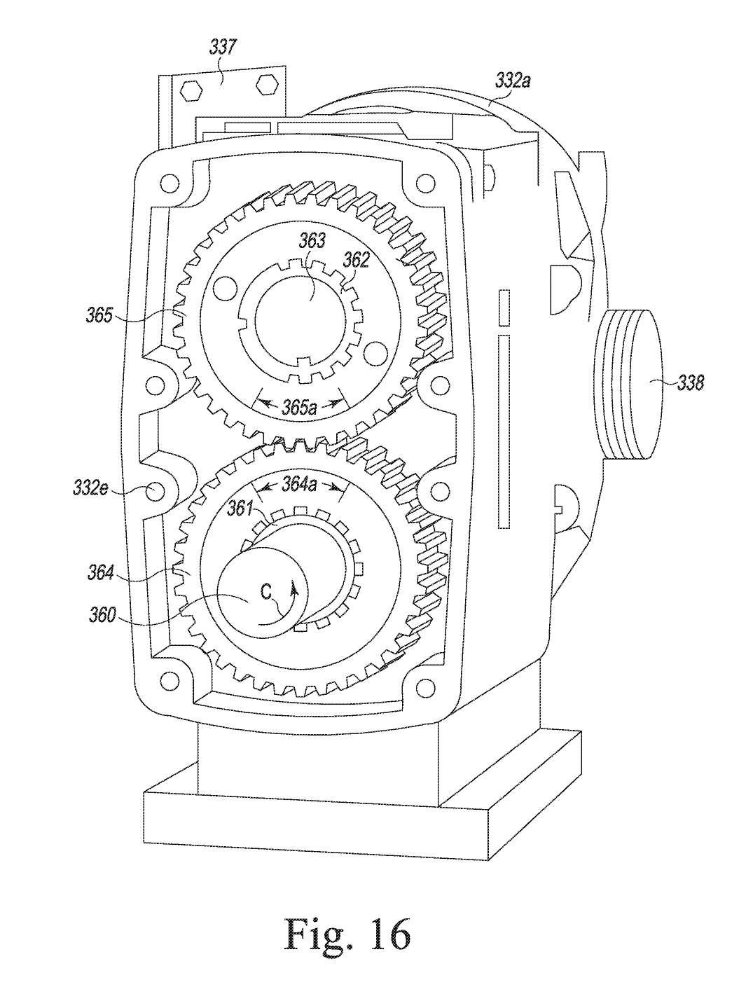

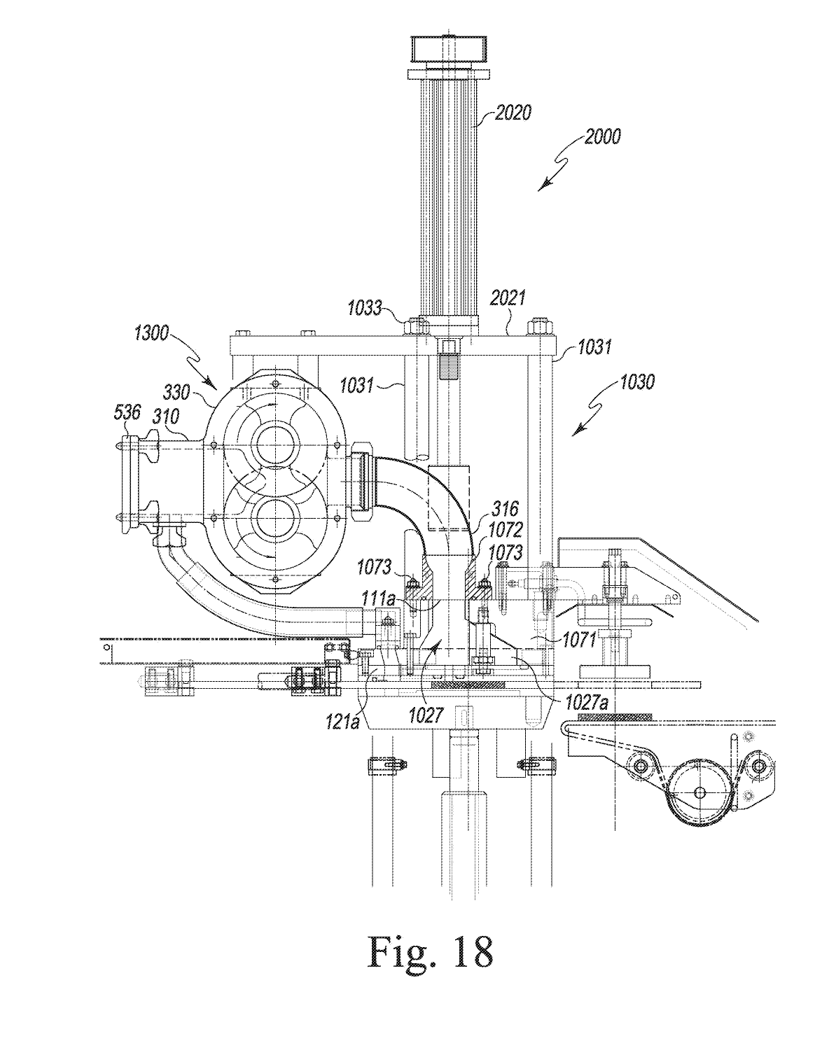

In another example, with reference to FIGS. 18-22, the molding machine comprises a pump system 1300 connected to a fill plunger system 2000 for pressurizing the food mass. The pump system 1300 and fill plunger system 2000 are together interfit between outlet flange 536 of the hopper and the fill plate 121a of the molding apparatus. The pump system includes the rotary pump 330 and the pump motor 350 together as previously described but mounted 90 degrees from the previously described example to a horizontal motor-to-pump orientation (see FIG. 20). The rotary pump output passage 316 channels the food mass from the pump into an intake manifold 1027. The intake manifold is similar to the manifold 27 except a truncated triangular cross-section block 1027a is bolted inside the manifold 1027 to decrease the degree of flare or expansion of the manifold in the longitudinal direction. This is done for example for single cavity filling of ground beef products through a slot fill to for operational reasons to reduce manifold volume to make some products more responsive to compression or pressurizing. The pump output passage 316 is connected to the intake manifold 1027 at the manifold inlet passage 111a. The intake manifold 1027 is enclosed within a lower housing 1071. An upper housing 1072 is disposed above the lower housing 1071 and secured to the lower housing 1071 using flange nuts and studs 1073. The manifold inlet passage 111a is open into the upper housing 1072.

In one example, the fill plunger system 2000 comprises a pair of plungers 2010. Plungers 2010 move between a raised position and an extended position. In the illustrated example, the plungers 2010 are positioned above the intake manifold 1027 and move toward and away from a top of the intake manifold. In its raised position, the tip 2011 of the plunger is within the upper housing 1072 just above the intake manifold 1027. In an extended position, the plunger extends into the intake manifold 1027 to displace a pre-determined volume of food mass in the intake manifold. The upper housing 1072 comprises a plunger channel 1075 in communication with an opening 1076 into the intake manifold to allow vertical movement of the plunger through the plunger channel 1075 and into the intake manifold. The vertical movement of the plunger 2010 into the intake manifold 1022 varies the volume, and accordingly the pressure of the food mass within the intake manifold. The increase in food mass pressure as a result of the displacement of the food mass in the manifold can be coordinated with the reciprocating movement of the mold plate. For example, pressure may be increased within the intake manifold using the fill plunger system prior to the mold cavity coming into communication with the intake manifold by beginning the downward stroke of the plunger, and continuing the downward stroke of the plunger into the manifold as the mold plate slides into the fill position. Various other timing combinations of the plunger movement and the mold plate movement can be used to achieve the desired mold cavity filling dynamic.

To ensure a secure seal between the plunger channel 1075 and the plunger 2010 such that food mass does not escape from the plunger channel 1075, a seal, such as a rubber or silicone O-ring is disposed along the circumference of the plunger channel 1075. Any other suitable seal known to one skilled in the art can also be used.

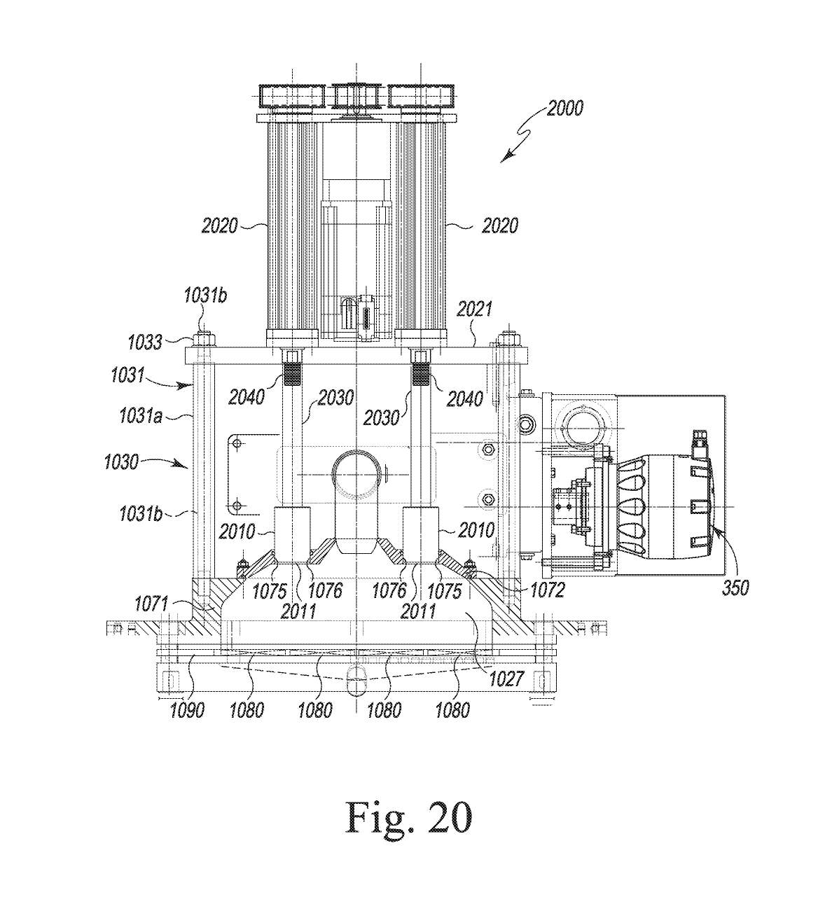

Movement of the plungers 2010 are controlled by a linear actuator 2020. Plungers 2010 are connected to a plunger shaft 2030, which are connected to an actuating rod 2050 (FIG. 22) as part of the linear actuator 2020. The actuators 2020 are supported on top of a platform 2021, which is secured to the lower housing 1071 by a support frame 1030 comprising vertical supports 1031. Vertical supports 1031 each comprise an external tube 1031a with an internal threaded shaft 1031b (FIG. 20). The shaft extends out opposite ends of the tube and is threaded into the lower housing 1071 and receives a nut 1033 on top to secure the platform 2021 to the vertical supports 1031, and to the lower housing 1071.

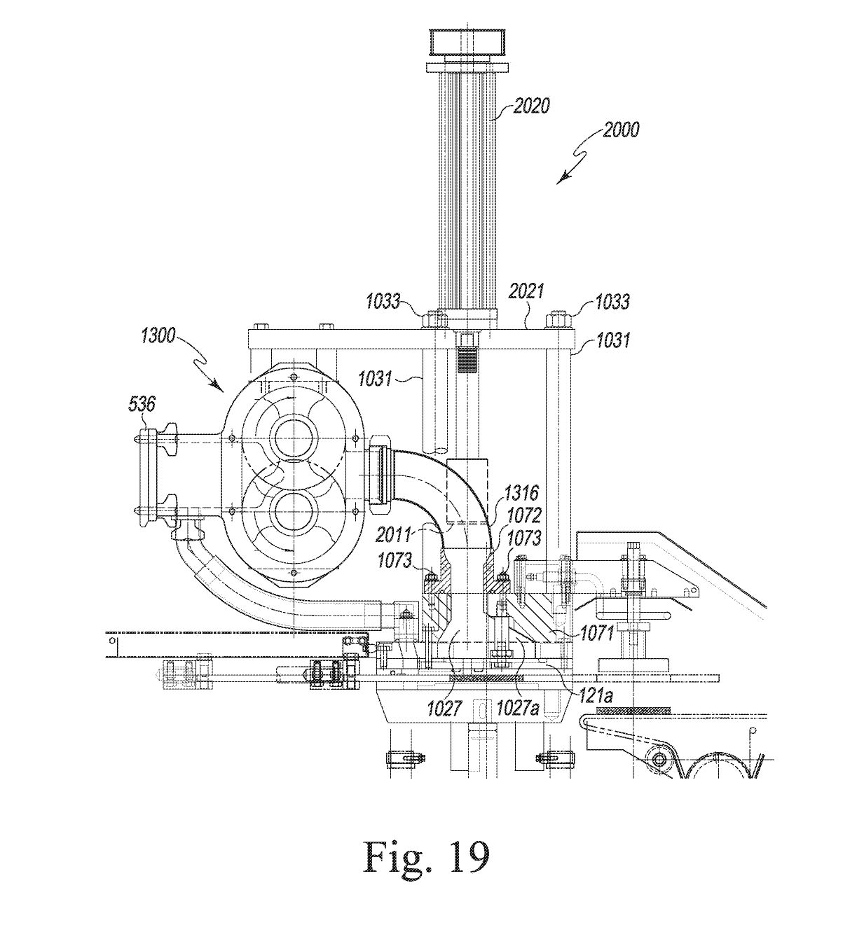

One example of the drive mechanism for the linear actuators 2020 is illustrated in FIGS. 21 and 22. Revolution of a pair of toothed driven gears 2060 disposed at the top of the pair of linear actuators 2020 extends and retracts the actuating rods 2050 by an internal screw drive or other rotary-to-linear movement converter. The toothed driven gears are driven by a toothed belt 2080, driven by a toothed driving gear 2070. Toothed driving gear 2070 is connected at the center of the gear to a motor 2090, such as a servomotor. The motor drives the gear 2070 which simultaneously drives both toothed driven gears 2060 such that the movement of the two plungers are in synchronization. Any other suitable method of driving the driving gear, such as the use of a drive belt, can also be used.

Other manners of driving the plungers can be used, such as servomotor linear actuators, pneumatic or hydraulic cylinders, etc.

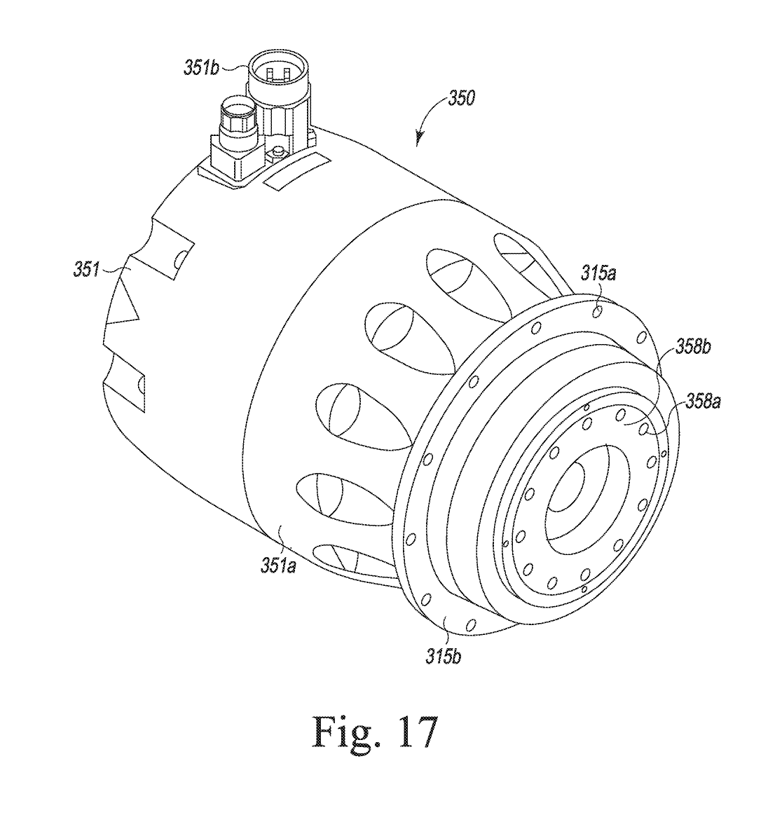

Plungers can be any suitable size or shape, providing the desired cross-sectional area and volume of food mass displacement, and accordingly, the desired increase in pressure for a particular type of food mass and/or mold plate. The shape of the intake manifold opening 1076 and the plunger channel 1075 are shaped accordingly to complement the shape and size of the plungers. The extension distance of the plungers into the manifold can vary according to the desired fill pressure. The fill plunger system can be used with any type of mold plate 1090. In one example, the plunger in its raised position may be raised such that the tip 2011 of the plunger is above the upper housing 1072, as illustrated in FIG. 19.

In one example, the plunger in its extended position extends into the upper housing 1072, but remains above the manifold.

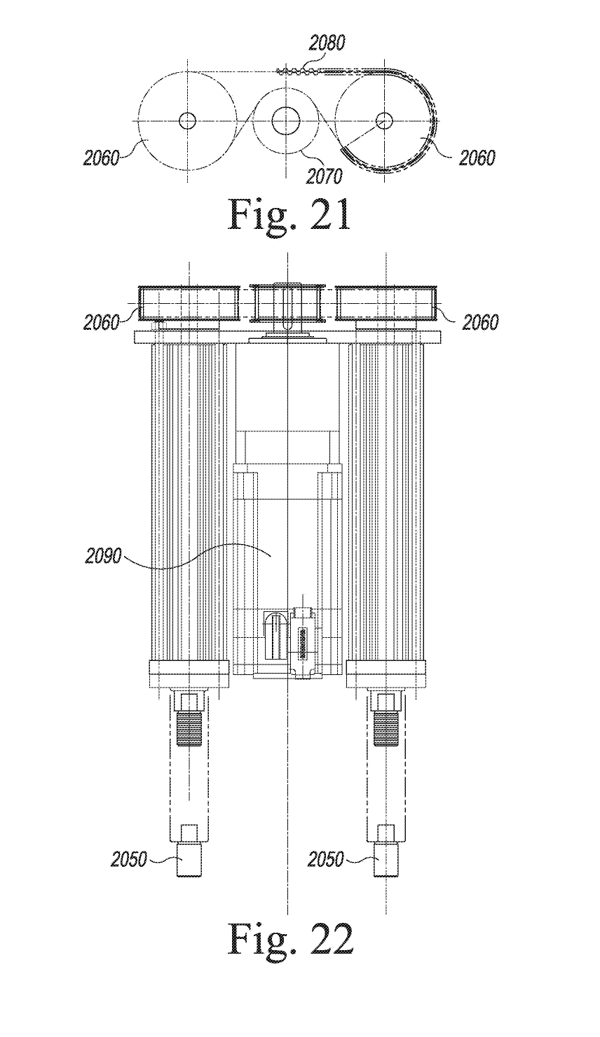

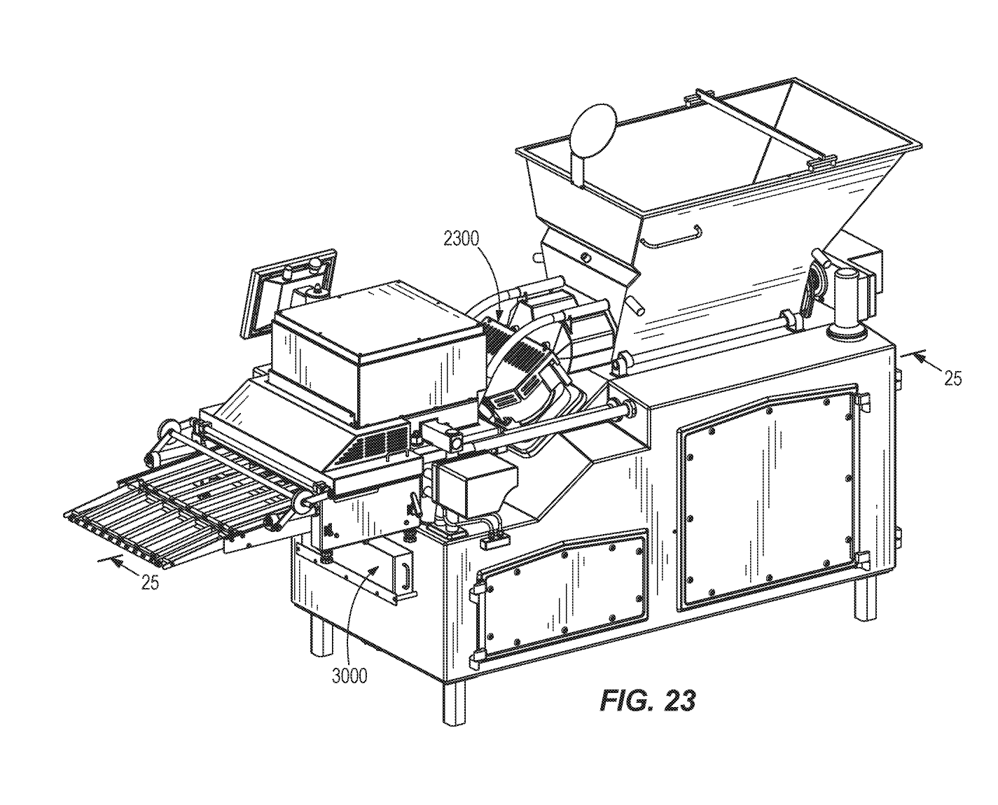

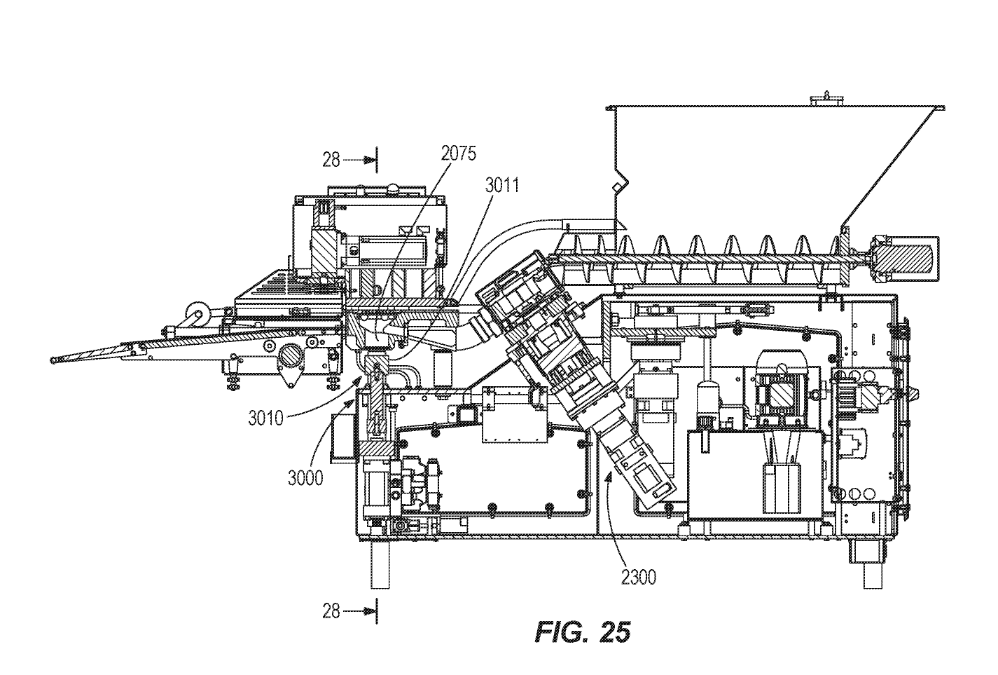

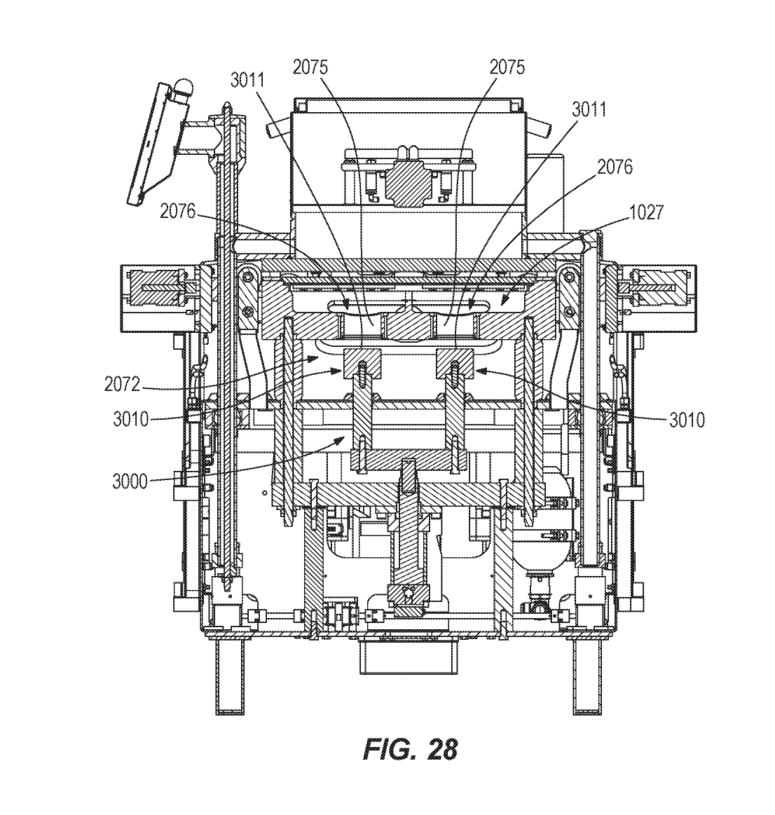

In another example, with reference to FIGS. 23-30, the molding machine comprises a pump system 2300 connected to a fill plunger system 3000 for pressurizing the food mass. The pump system 2300 and fill plunger system 3000 are together interfit between outlet flange 536 of the hopper and the fill plate 121a of the molding apparatus. The pump system 2300 includes the rotary pump and the pump motor.

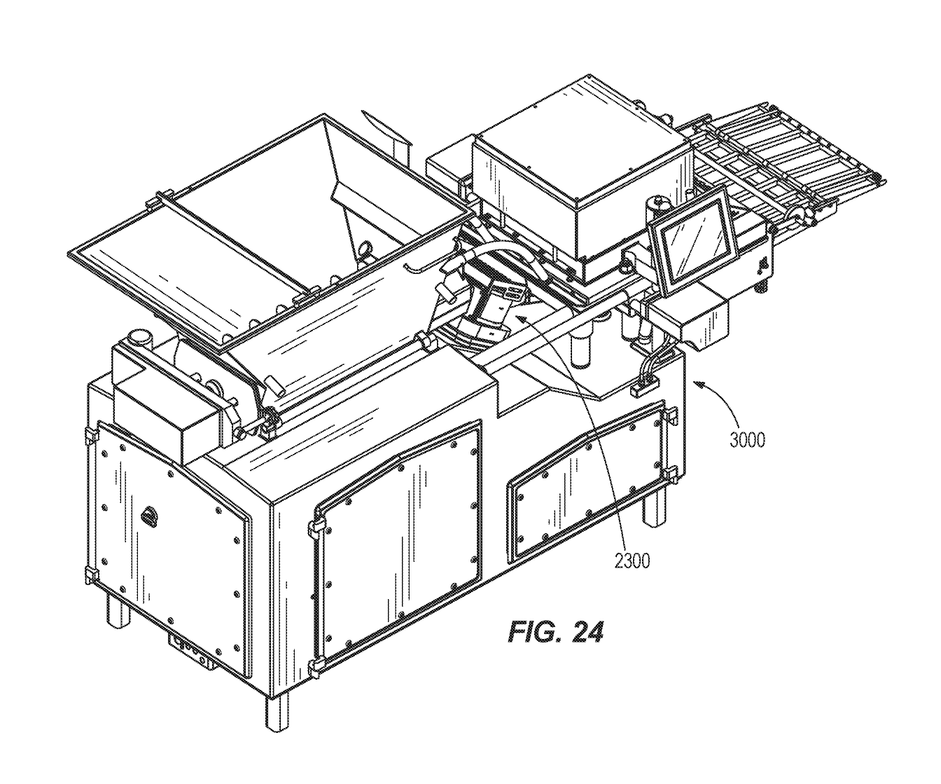

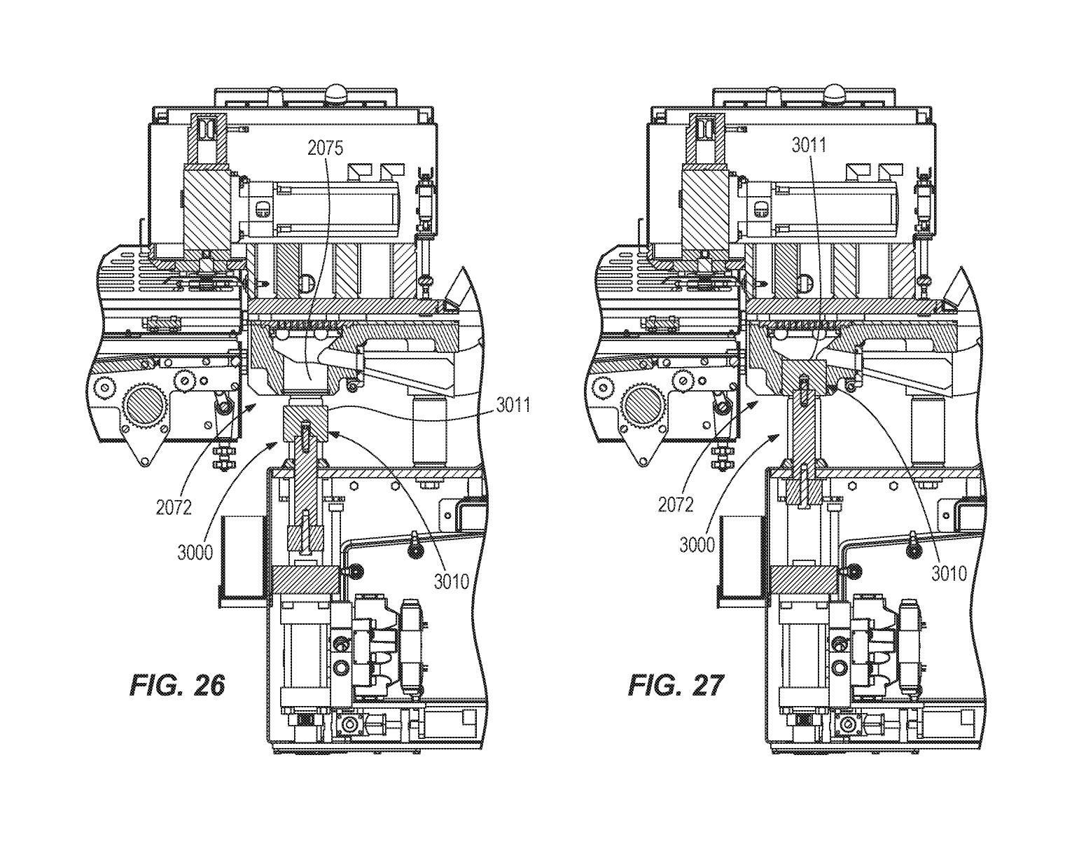

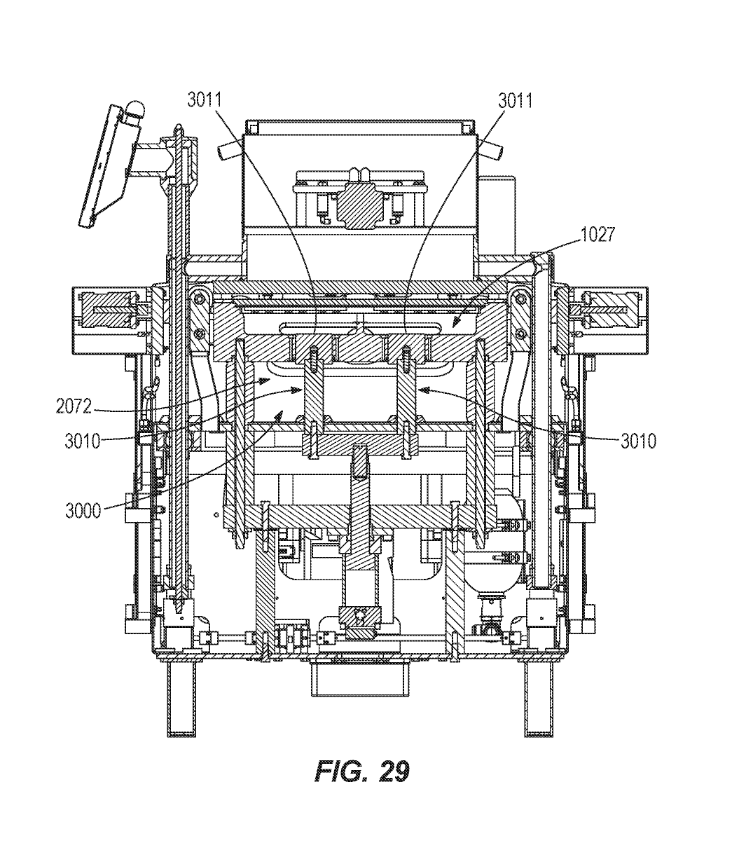

In one example, the fill plunger system 3000 comprises a pair of plungers 3010. In the illustrated example, the plungers 3010 are positioned below the intake manifold 1027 and move toward and away from a bottom of the intake manifold 1027 between a lowered or retracted position (see FIGS. 25, 26 and 28) and an extended, raised or depressed position (see FIGS. 27 and 29). The plungers 3010 move into and out of the intake manifold 1027 from below the intake manifold 1027. In the retracted or lowered position, the tip 3011 of each plunger 3010 may be either within a lower housing 2072 just below the intake manifold 1027 or may be below the lower housing 2072. In the extended or raised position, the plungers 3010 extend into the intake manifold 1027 to displace a pre-determined volume of food mass in the intake manifold 1027. The lower housing 2072 comprises plunger channels 2075 in communication with openings 2076 into the intake manifold 1027 to allow vertical movement of the plungers 3010 through the plunger channels 2075 and into the intake manifold 1027. The vertical movement of the plungers 3010 into the intake manifold 1027 varies the volume, and accordingly the pressure of the food mass within the intake manifold 1027. The increase in food mass pressure as a result of the displacement of the food mass in the manifold 1027 can be coordinated with the reciprocating movement of the mold plate 1090. For example, pressure may be increased within the intake manifold 1027 using the fill plunger system 3000 prior to the mold cavity coming into communication with the intake manifold 1027 by beginning the upward stroke of one or more of the plungers 3010, and continuing the upward stroke of one or more of the plungers 3010 into the manifold 1027 as the mold plate slides into the fill position. Various other timing combinations of the plungers' movement and the mold plate movement can be used to achieve the desired mold cavity filling dynamic.

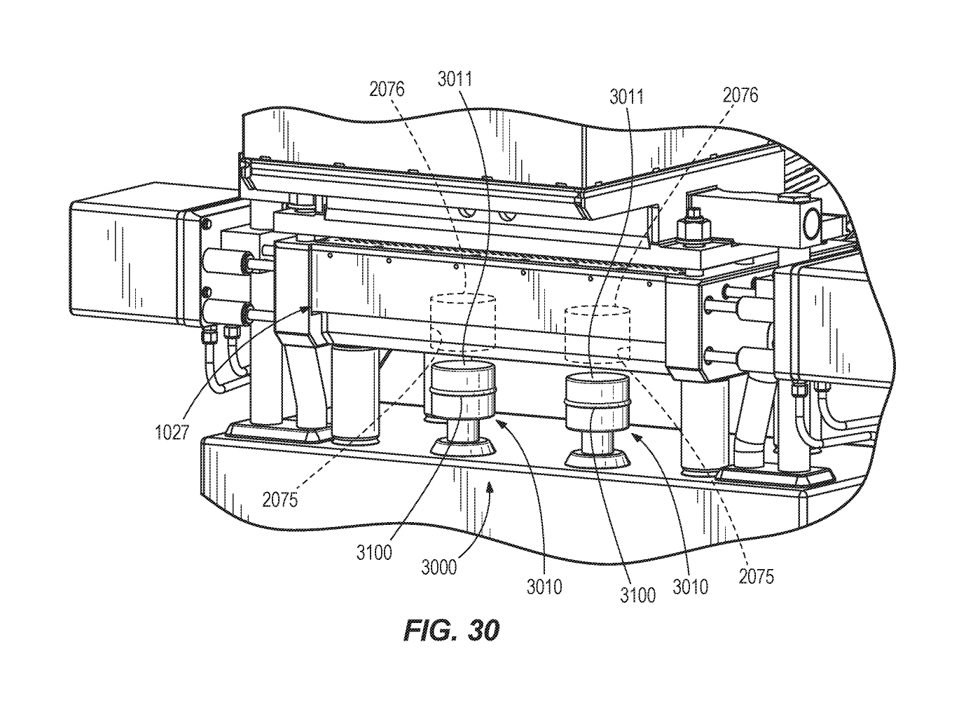

In one example, to ensure a secure seal between the plunger channels 2075 and the plungers 3010 such that food mass does not escape from the plunger channels 2075, a seal 3100 may be disposed along a circumference of each of the plungers 3010. In one example, with reference to FIG. 30, the seal 3100 may be an O-ring made of, for example, rubber, silicone or other resilient material. Any other suitable seal can also be used. In another example, the seal 3100 may be disposed on or in a wall of the plunger channels 2075 and engage a circumference of the plungers 3010.

Movement of the plungers 3010 may be controlled by one or more hydraulic cylinders. Plungers 3010 may also be controlled in a variety of other manners and all of such possibilities are intended to be within the spirit and scope of the present disclosure. For example, the plungers 3010 may be driven using servomotor linear actuators, pneumatic cylinders, or any other type of drive members.

In one example, the plungers 3010 may move together, in synchronization or simultaneously in the same direction. In another example, the plungers 3010 may move in an alternating manner or in some other offset manner.

Plungers 3010 can be any suitable size or shape, providing the desired cross-sectional area and volume of food mass displacement, and accordingly, the desired increase in pressure for a particular type of food mass and/or mold plate. The shape of the intake manifold opening 2076 and the plunger channels 2075 may be shaped accordingly to complement the shape and size of the plungers 3010. The extension distance of the plungers 3010 into the manifold 1027 may vary according to the desired fill pressure. The fill plunger system 3000 can be used with any type of mold plate 1090. In one example, the plungers 3010 in their lowered position may be lowered such that the tips 3011 of the plungers 3010 are below the lower housing 2072, as illustrated in FIGS. 25, 26 and 28. In one example, the plungers 3010 in their lowered position may be lowered such that the tips 3011 of the plungers 3010 are within the plunger channels 2075.

In one example, the plungers 3010, in their extended or raised position, extend into the lower housing 2072, but remains below the manifold 1027. In one example, the tips 3011 of the plungers 3010, in their extended or raised position, extend into the manifold 1027.

As shown in FIGS. 1-4 and 9-12, the upper surface of the housing 71 that encloses the manifold 27 carries a support plate or wear plate 121 and a fill plate 121a that forms a flat, smooth mold plate support surface. The manifold is supported by four support columns 71a, 71b. The support columns are connected to the machine base 21. The mold support plate 121 and the fill plate 121a may be fabricated as two plates as shown or a single plate bolted to or otherwise fixedly mounted upon housing 71. The fill plate 121a includes apertures or slots 121b that form the upper portion of the manifold inlet passage 111. In the apparatus illustrated, a multi fill orifice type fill plate 121a is utilized. A simple slotted fill plate is also encompassed by the present disclosure.

Mold plate 32 is supported upon plates 121, 121a. Mold plate 32 includes a plurality of individual mold cavities 126 extending across the width of the mold plate and alignable with the manifold outlet passageway 111c. The mold plate may have a single row of cavities or may have plural rows of cavities, stacked in aligned columns or in staggered columns. A breather plate or cover plate 122 is disposed immediately above mold plate 32, closing off the top of each of the mold cavities 126. A mold cover casting or housing 123 is mounted upon cover plate 122. The spacing between cover plate 122 and support plate 121 is maintained equal to the thickness of mold plate 32 by support spacers (not shown) mounted upon support plate 121. Cover plate 122 rests upon spacers 124 when the molding mechanism is assembled for operation. Cover plate 122 and mold cover casting 123 are held in place by four mounting bolts, or nuts tightened on studs 125.

The cover plate 122 can be configured as a breather plate as part of a molding mechanism air-and-fines removal system, such as described in U.S. Pat. No. 6,416,314, U.S. Pat. No. 7,416,753, or U.S. Ser. No. 10/942,755, filed on Sep. 16, 2004, each of which are herein incorporated by reference. In one example, the breather plate 122 provides breather holes 216 and an associated air channel 122 flow connected to the breather holes for allowing the expulsion of air during filling of the mold cavities 126. The breather holes 216 are minute air outlet holes formed in the breather plate, in the part of the breather plate adjacent fill slots 121b. As the food product is pumped into mold cavities 126, it displaces the air in the mold cavities. The air is forced outwardly through the apertures 216 and the air channel 122 and an upwardly extending channel 122c. Any food particles small enough to pass through the apertures 216 follow this same path back into the food product hopper. The air channel 122 is connected to an upward air channel 122c that may be connected to the hopper by a suitable conduit, such as a pipe (not shown) to recycle food product that might be expelled with the air into the air channel. Alternatively the air channel may be connected to the intake of the pump 330. The pump may have a low pressure on the intake side which create vacuum to draw air through from the cavity and through the air channel 122, 122c.

As best illustrated in FIGS. 4 and 5, mold plate 32 is connected to drive rods 128 that extend alongside housing 71 and are connected at one end to a transverse bar 129. The mold plate drive system 500 comprises the drive rods 128, the mold plate drive motors 138, 138d and the associated linkages. The other end of each drive rod 128 is pivotally connected to a connecting link 131 via a machine 100 plate 131a and a pivot connection 131c, shown in FIG. 5. The pivot connection 131c can include a bearing (not visible in the figures) surrounding a pin within an apertured end of the connecting link 131. The pin includes a cap, or carries a threaded nut, on each opposite end to secure the crank arm to the machine 100 plate 131a.

Each drive rod 128 is carried within a guide tube 132 that is fixed between a wall 134 and a front bearing housing 133. The connecting links 131 are each pivotally connected to a crank arm 142 via a pin 141 that is journaled by a bearing 141a that is fit within an end portion of the connecting link 131. The pin crank arm 142 is fixed to, and rotates with, a circular horizontal guard plate 135. The pin 141 has a cap, or carries a threaded nut, on each opposite end that axially fixes the connecting link 131 to the crank arm 142 and the circular guard plate 135. The pin 141 rotates the link on an orbit 141c about the motor output 138a. The connecting link 131 also includes a threaded portion 131b to finely adjust the connecting link length.

The crank arm 142 is driven by a precise position controlled servo mold plate drive motor 138. The motor is mounted vertically in the machine so that the output 138a rotates on a horizontal axis which is the same horizontal axis that the circular guard plate 135 rotates about. The crank arm 142 is attached to the output 138a to rotate the crank arm about the output 138a. The motor 138 is mounted to a motor support plate 138b that is mounted to and supported by the machine base 21. As shown in FIG. 7, the motor is mounted with the output 138a perpendicular to the support plate. The motor has power and control cables that are routed through a wiring conduit 138a to connect those wires to power and machine control 23. A precise position controlled servo mold plate drive motor 138d is identical to motor 138 but is mounted on the left side of the machine to drive the drive rod 128 on the left side of the machine as shown in FIG. 7. The mechanical configuration on the left side, regarding the mold plate drive motor and related connection are the same as that described for the right side above.

The machine control 23 has instructions for maintaining the two motors 138, 138d operating in sync so that each of the right and left drive rods have the same longitudinal position along their respective ranges of motion. This is necessary to ensure that both lateral sides of the mold plate are in the same longitudinal position with respect to the other and they operate in a parallel reciprocation. The mold plate is reciprocated by the synchronous output both motors 138 and 138d.

The precise position controlled motors 138, 138d can be a 6-7.5 HP totally enclosed fan cooled servo motor. The servo motor is provided with two modules: a power amplifier that drives the servo motor, and a servo controller that communicates precise position information to the machine controller 23. In one example, motors 138 comprise a motor 138e driving a gearbox or gear reducer 138f by a driveshaft 138g as shown in FIG. 7. The motor may be model 1FK7082-7AF71 manufactured by Siemens AG capable of 3000 RPMs and 124 in/lbs of torque. The gearbox may be an in-line gear box such as, an Alpha TP+050 MP manufactured by Wittenstein, Inc. with a place of business in Bartlett, Ill.

In one example, the controller 23 and the servo motors 138, 138d are configured such that the servo motor rotates in an opposite rotary direction every cycle, i.e., clockwise during one cycle, counterclockwise the next cycle, clockwise the next cycle, etc.

A tie bar 139 is connected between the rods 128 to ensure a parallel reciprocation of the rods 128. As the crank arms 142 rotate in opposite rotational directions, the outward centrifugal force caused by the rotation of the crank arms 142 and the eccentric weight of the attached links 131 cancels, and separation force is taken up by tension in the tie bar 139.

One circular guard plate 135 is fastened on top of each crank arm 142. The pin 141 can act as a shear pin. If the mold plate should strike a hard obstruction, the shear pin can shear by force of the crank arm 142. The guard plate 135 prevents an end of the link 131 from dropping into the path of the crank arm 142.

FIG. 5 illustrates a proximity sensor 144 in communication with the machine control 23. A target 144a is clamped onto output shaft 138a of the motor 138. The proximity sensor 144 communicates to the controller 23 that the crank arm 142 is at a particular rotary position corresponding to the mold plate 32 being at a pre-selected position. Preferably, the proximity sensor 144 can be arranged to signal to the controller that the crank arm 142 is in the most forward position, corresponding to the mold plate 32 being in the knockout position. The signal confirms to the controller that the knockout cups 33 can be safely lowered to discharge patties, without interfering with the mold plate 32.

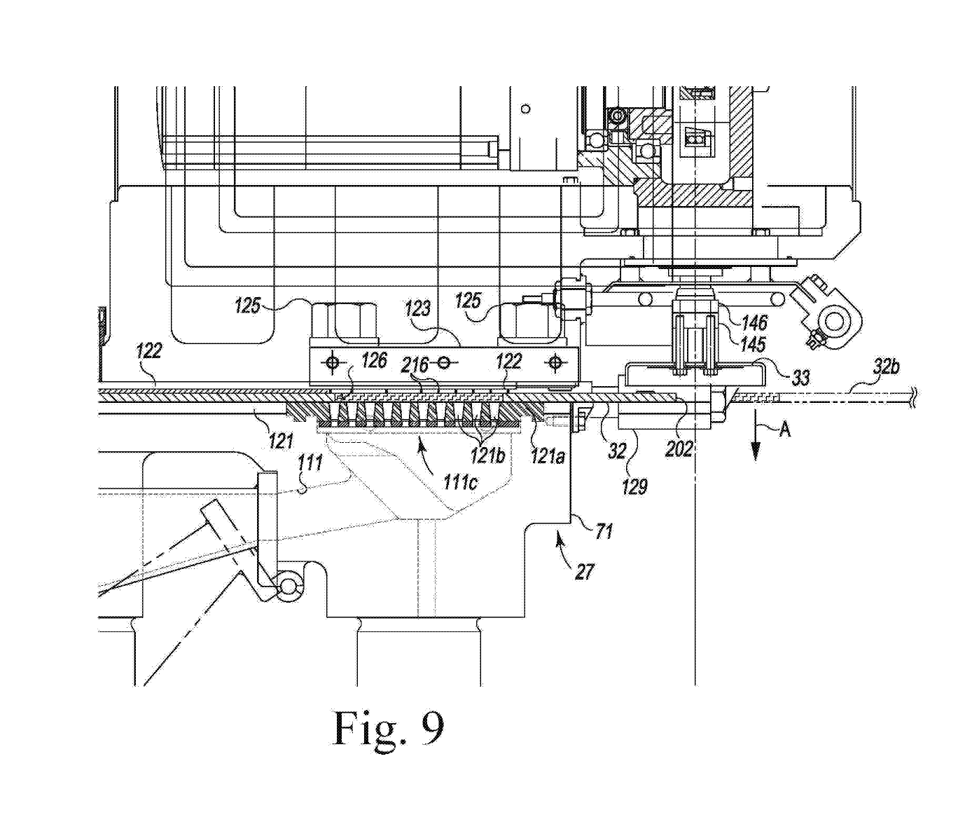

During a molding operation, the molding mechanism 28 is assembled as shown in FIGS. 2 and 9, with cover plate 122 tightly clamped onto spacers 124.

In each cycle of operation, knockout cups 33 are first withdrawn to the elevated position as shown in FIG. 9. The drive for mold plate 32 then slides the mold plate from the full extended position to the mold filling position with the mold cavities 126 aligned with passageway 111.

During most of each cycle of operation of mold plate 32, the knockout mechanism remains in the elevated position, shown in FIG. 9, with knockout cups 33 clear of mold plate 32. When mold plate 32 reaches its extended discharge position 32b, the knockout cups 33 are driven downward in direction A to discharge the patties from the mold cavities.

The discharged patties may be picked up by the conveyor (not shown) or may be accumulated in a stacker. If desired, the discharged patties may be interleaved with paper, by an appropriate paper interleaving device, and such a device is disclosed in U.S. Pat. No. 3,952,478 or 7,159,372, both incorporated herein by reference to the extent not inconsistent with the present description. In fact, machine 100 may be used with a wide variety of secondary equipment, including steak folders, bird rollers, and other such equipment.

By using a servo motor to drive the mold plate, the mold plate motion can be precisely controlled. The motion can have a fully programmable dwell, fill time, and advance and retract speeds as controlled by the machine control 23.

Molding mechanism 28 further comprises a knockout mechanism or apparatus 140 shown in FIGS. 2, 9-12. In one example, the knockout mechanism may be that which is disclosed in U.S. Pat. No. 7,255,554, which is incorporated by reference to the extent not inconsistent with the description provided here. The knockout apparatus comprises the knockout plungers or cups 33, which are fixed to a carrier bar 145. Knockout cups 33 are coordinated in number and size to the mold cavities 126 in the mold plate 32. One knockout cup 33 is aligned with each mold cavity 126. The mold cavity size is somewhat greater than the size of an individual knockout cup. The knockout apparatus 140 is configured to drive the carrier bar 145 in timed vertical reciprocation.

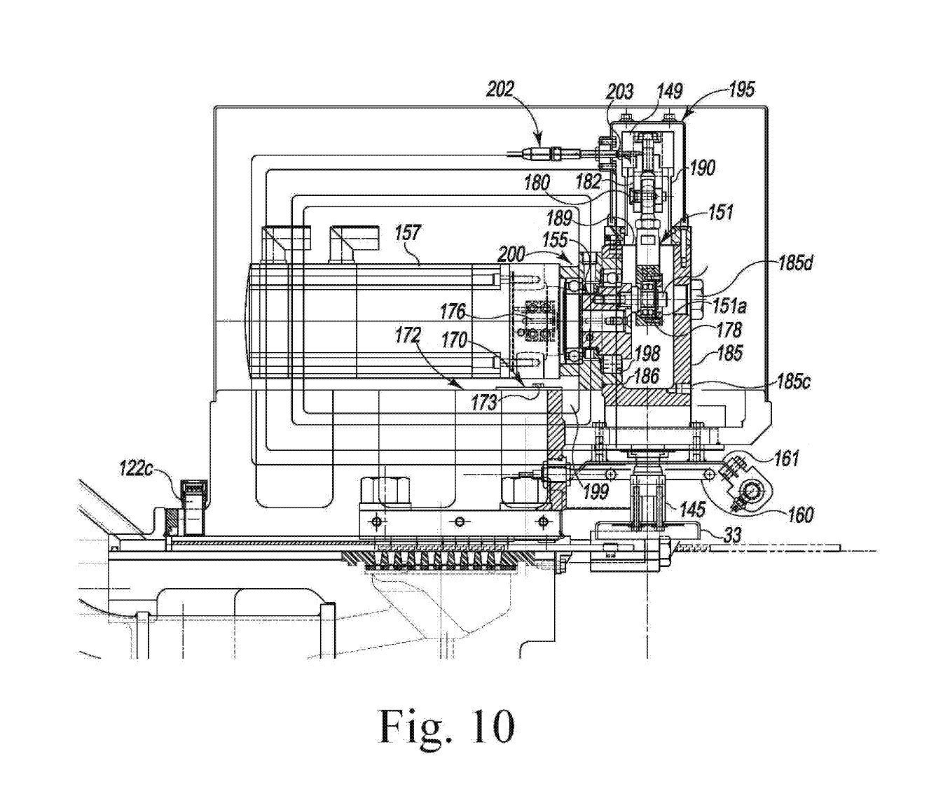

FIGS. 10-12 illustrate the knockout apparatus 140 in more detail. The carrier bar 145 is fastened to knockout support brackets 146a, 146b. The knockout support brackets 146a, 146b are carried by two knockout rods 147. Each knockout rod 147 is disposed within a wall of a knockout housing 148 and is connected to a knockout beam 149. The knockout beam 149 is pivotally mounted to a crank rod 151 that is pivotally connected to a fastener pin 156 that is eccentrically connected to a crank hub 155 that is driven by a knock out cup drive motor 157. The knock out drive motor is located above the mold plate.

The motor 157 is preferably a precise position controlled motor, such as a servo motor. An exemplary servomotor for this application is a 3000 RPM, 2.6 kW servo motor provided with a brake, such as a permanent-magnet synchronous servo motor made by Siemens AG having a model number of 1FK7064-7AF71-1GB0. The servo motor is provided with two modules: a power amplifier that drives the servo motor, and a servo controller that communicates precise position information to the machine controller 23.

The controller 23 and the motor 157 are preferably configured such that the motor rotates in an opposite direction every cycle, i.e., clockwise during one cycle, counterclockwise the next cycle, clockwise the next cycle, etc.

A heating element 160 surrounds, and is slightly elevated from the knockout carrier bar 145. A reflector 161 is mounted above the heating element 160. The heating element heats the knock out cups to a pre-selected temperature, which assists in preventing food product from sticking to the knock out cups. The heating element 160 can be configured as disclosed in U.S. Ser. No. 13/187,426 filed on Jul. 20, 2011, and herein incorporated by reference to the extent not inconsistent with the present disclosure.

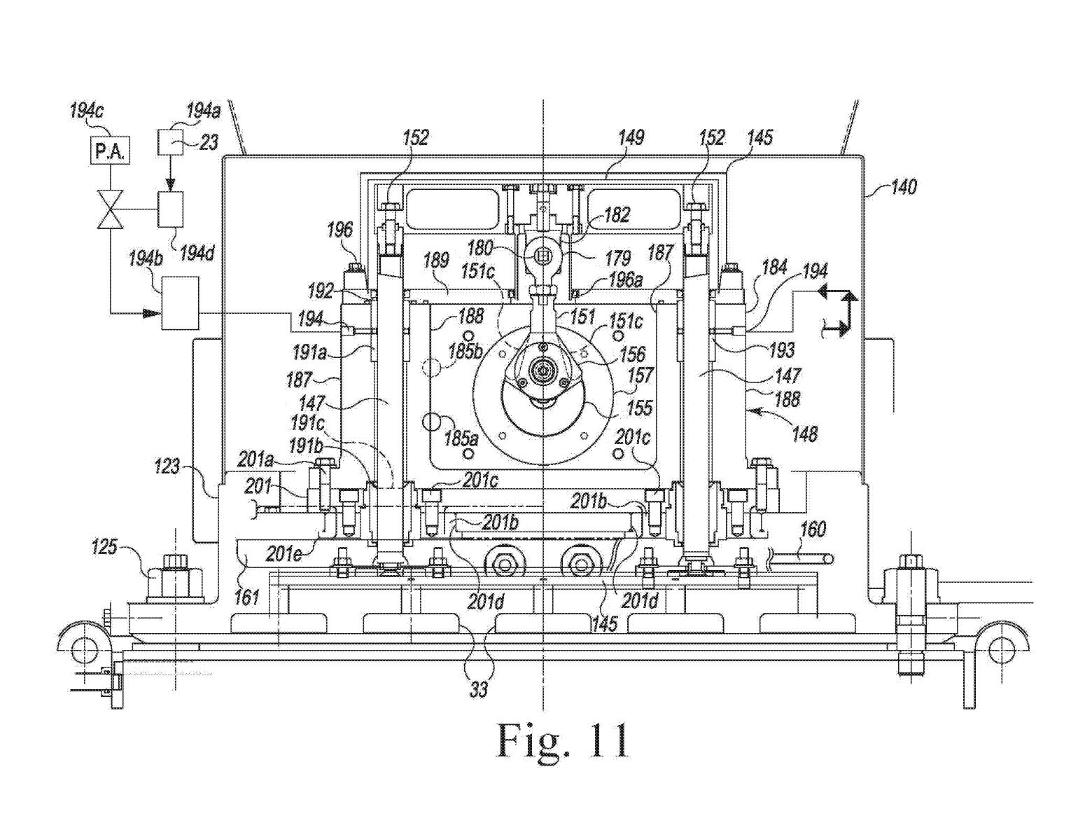

In FIGS. 10 and 11, the crank hub 155 is rotated into a position wherein the crank rod 151 is vertically oriented and the knockout beam 149 is lifted to its maximum elevation. The knockout rods are fastened to the knockout beam 149 by fasteners 152. The knockout support brackets 146a, 146b are in turn fastened to the knockout rods 147 by fasteners 153. Each knockout cup 33 is fastened to the knockout carrier bar by a pair of fasteners 154a and spacers 154b. An air flap or air check valve 33a can be provided within each cup to assist in dispensing of a meat patty from the cup 33.

As shown in FIG. 10, the motor 157 is supported by a bracket 170 from a frame member 172 that is mounted to the casting 123. The bracket 170 includes one or more slotted holes, elongated in the longitudinal direction (not shown). One or more fasteners 173 penetrate each slotted hole and adjustably fix the motor 157 to the frame member. The motor 157 includes an output shaft 176 that is keyed to a base end of the crank hub 155. The fastener pin 156 retains a roller bearing 178 thereon to provide a low friction rotary connection between an annular base end 151a of the crank rod 151 and the pin 156.

The crank rod 151 has an apertured end portion 179 on an upper distal end 151b opposite the base end 151a. The apertured end portion 179 is held by a fastener pin assembly 180 through its aperture to a yoke 182. The yoke 182 is fastened to the knockout beam 149 using fasteners. The fastener pin assembly 180 can include a roller or sleeve bearing (not shown) in like fashion as that used with the fastener pin 156 to provide a reduced friction pivot connection.

The housing 148 is a substantially sealed housing that provides an oil bath. Preferably, the housing walls and floor is formed as a cast aluminum part. The crank hub 155, the pin 156, roller bearing 178, the apertured end portion 179, the fastener pin 180 and the yoke 182 are all contained within the oil bath having an oil level 183. The limits of the oil bath are defined by a housing 184 having a front wall 185, a rear wall 186, side walls 187, 188, a top wall 189 and a sleeve 190. The sleeve 190 is a square tube that surrounds a substantial portion of the crank rod 151 and is sealed around its perimeter to the top wall 189 by a seal element 196a. The sleeve 190 is connected to the beam 149 and penetrates below the top wall 189. As the yoke 182 reciprocates vertically, the beam 149 and the sleeve 190 reciprocate vertically, the sleeve 190 maintaining a sealed integrity of the oil bath.

The crank rod 151 includes side dished areas 151c that act to scoop and propel oil upward during rotation of the hub 155 to lubricate the pin 180 and surrounding areas.

The knockout rods 147 are guided to reciprocate through the side walls 187, 188, particularly, through upper and lower bearings 191a, 191b. The rods 147 are sealed to the top wall by seals 192. The bearings 191a can include an internal groove 193 that is in flow-communication with a lubricant supply through port 194.

A lubricant system 194a is provided to provide lubricant to the bearings 191a, 191b. The system 194a includes a lubricant reservoir 194b that is filled with lubricant, such as oil, and connected to plant air 194c via an electronically controlled valve 194d. The machine controller 23 periodically, according to a preset routine, actuates the valve 194d to propel some lubricant into the bearings 191a. Lubricant can run down the knockout rod 147 into a dished top 191c of the lower bearings 191b to allow oil to penetrate between the knockout rods 147 and the lower bearings 191b.

An outer cover 195 is fastened and sealed around the side walls 187, 188 and front and rear walls 185, 186 by fasteners, spacers 196 and a seal 197. Any lubricating oil that passes through the seal can be returned to the oil bath via dished out drain areas and drain ports through the top wall.

The front wall 185 includes an oil level sight glass 185a, a fill port 185b (shown dashed in FIG. 11), a drain port 185c (FIG. 10); and an access hole closed by a screw 185d (FIG. 10).

The crank hub 155 is journaled for rotation by two roller bearings 198, 199. The roller bearings 198, 199 are supported by a collar assembly 200 bolted to the rear wall 186 and to the motor 157.

The knockout assembly is changeable to extend further forwardly to minimize knockout cup cantilever. This is accomplished by loosening the bracket 170 from the frame member 172 and sliding the motor and all the connected parts forward or rearward and replacing circular adapter plates for the knockout rods 147.

The housing 148 is fastened to a support plate 201 by fasteners 201a. The support plate 201 is fastened to circular adapter plates 201b by fasteners 201c. The circular adapter plates 201b are removably fit into circular holes 201d in the casting 123. The circular adapter plates 201b include a bottom flange 201e which abuts the casting 123. The circular adapter plates 201b surround the bearings 191b and associated bearing assemblies 191c.

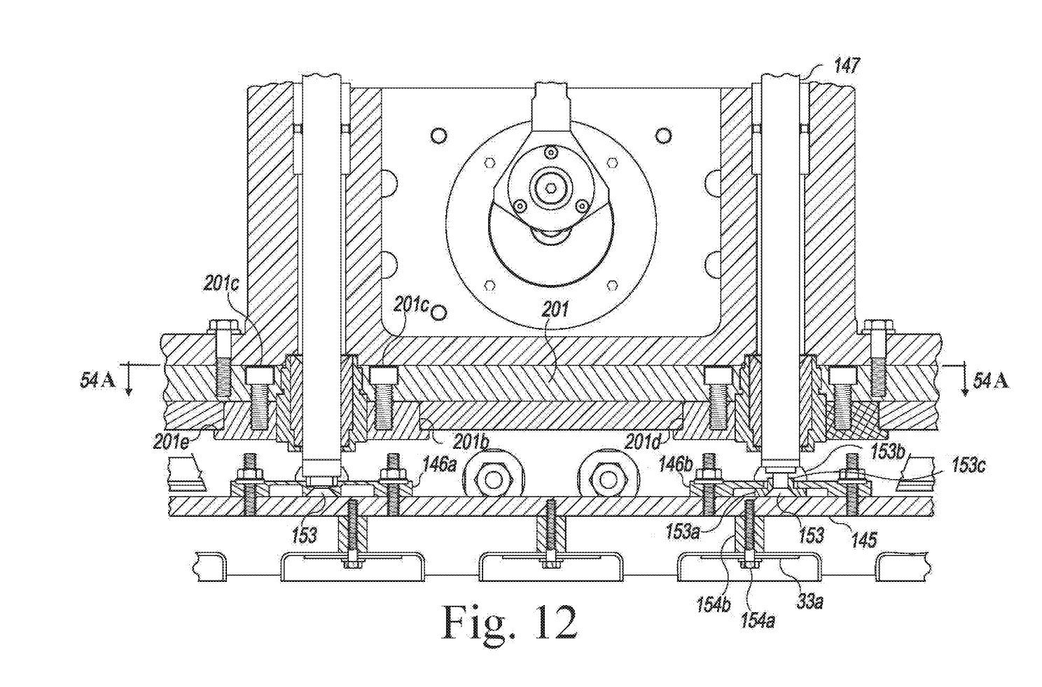

As shown in FIG. 12, the left bracket 146a is fixedly connected to the left knockout rod 147 using the fastener 153 while the right bracket 146b is connected for a sliding connection. In this regard the right fastener 153 passes through an inverted T-nut 153a that passes through the bracket 146b and fits into a backup washer 153b that abuts the top side of the bracket 146b. The bracket 146b includes an oversized opening in the lateral direction that allows the bracket 146b to shift laterally with respect to the T-nut and knockout rod 147. This arrangement allows the bar 145 to expand and contract laterally with respect to the knockout rods 147. When the knockout cups 33 are heated by the heating element 160, the carrier bar 145 can become heated as well. Preferably, the carrier bar 145 is composed of aluminum which can expand to a significant degree. The sliding connection of the bracket 146b accommodates this thermal expansion.

The knockout assembly is changeable to extend further forwardly to minimize knockout cup cantilever and stress in supporting members. This is accomplished by loosening the bracket 170 from the frame member 172 and sliding the motor 157 and the connected parts forward or rearward and replacing the circular adapter plates that guide the knockout rods 147.

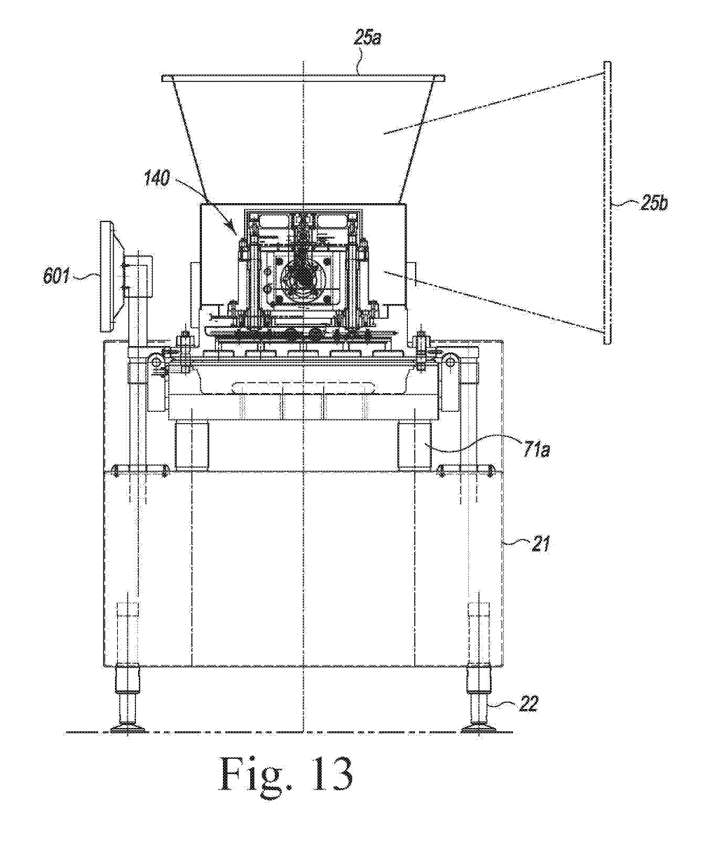

As demonstrated in FIG. 13A, to change the longitudinal position of the knockout cups 33, the support plate 201 is shifted longitudinally. Replacement circular adapter plates 201bb are fit into the casting 123 from below. The replacement circular adapter plates 201bb include different hole patterns for the knockout rods 147, forwardly or rearward shifted, to accommodate the new position of the support plate 201.

A proximity sensor 202 is bolted to the outer cover 195, and a target 203 is provided on the crank beam 149 to be sensed by the proximity sensor 202. The proximity sensor 202 communicates to the controller 23 that the knockout cups are raised and the mold plate can be retracted without interfering with the knockout cups.

The movement of the knockout cups is fully programmable for different motion profiles, including dwell, accelerations and extend and retract speeds. Such motion profiles may be useful depending on the properties of the food product to be discharged from the mold plate cavities. Because both the mold plate and the knockout cups can be driven by programmable, controlled servo motors, they can be flexibly sequenced without being restricted in motion by a common mechanical system.

The hopper tilt system and the control panel 23 are configured such that apparatus can be easily factory converted from a right side operating apparatus to a left side operating apparatus, that is, factory reversible across the longitudinal centerline of the apparatus.

The operation of the machine is controlled by the machine control 23. The machine control is schematically shown in FIG. 1. The machine control is signal connected to the rotary pump motor 350, the feed screw drive motors 406, 408, the mold plate drive motors 138, 138d, sensor 144, and the knock out cup drive motor 157. These connections allow the machine to control the operation of the various components of the machine. The connections allow the machine control to know the operating status of each component. The machine control has computer readable instructions for carrying out the functions and operations of the various parts of the machine as described above and for receiving and recording data about the same.

The machine control 23 can be implemented as a programmed general purpose computer, or a single special purpose integrated circuit (e.g., ASIC) having a main or central processor section for overall, machine control, and separate sections dedicated to performing various different specific computations, functions and other processes under control of the central processor section. The machine control 23 can be implemented using a suitably programmed general purpose computer, e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the procedures described or carrying out functions described herein can be used as the machine control 23.

The Abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

While various examples of the disclosure have been described, it will be apparent to those of ordinary skill in the art that other examples and implementations are possible within the scope of the disclosure. Accordingly, the disclosure is not to be restricted except in light of the attached claims and their equivalents.

Additionally, from the foregoing, it will be observed that numerous variations and modifications may be effected without departing from the spirit and scope of the present disclosure. It is to be understood that no limitation with respect to the specific apparatus illustrated herein is intended or should be inferred.

What is claimed is:

1. A food product forming machine, comprising:
a food supply;
a rotary food pump in communication with the food supply and including a pump outlet;
a molding mechanism having a mold plate with a mold cavity, the mold plate configured to be reciprocated by a mold plate drive between a cavity fill position and a cavity discharge position;
a knockout drive configured to reciprocate a knockout plunger to discharge molded food products from the mold cavity in the mold plate;
a manifold including a manifold inlet and an outlet passageway, wherein the manifold inlet is in communication with the outlet of the food pump and the outlet passageway is in communication with an inlet of the molding mechanism for filling the mold cavity of the mold plate; and
a fill plunger positioned below the manifold and configured to reciprocate between a retracted position and an extended position.

2. The food product forming machine of claim 1, wherein the fill plunger is a first fill plunger, the food product forming machine further comprising a second fill plunger positioned below the manifold and configured to reciprocate between a retracted position and an extended position.

3. The food product forming machine of claim 2, wherein the first and second fill plungers move together in synchronization between the retracted and extended positions.

4. The food product forming machine of claim 1, further comprising a lower housing positioned below the manifold, wherein a plunger channel is defined in the lower housing and configured to receive the fill plunger therein.

5. The food product forming machine of claim 4, wherein the plunger channel opens into a bottom of the manifold.

6. The food product forming machine of claim 5, wherein the fill plunger is a first fill plunger and the plunger channel is a first plunger channel, the food product forming machine further comprising a second fill plunger and a second plunger channel, wherein the second fill plunger is positioned below the manifold and configured to reciprocate between a retracted position and an extended position and the second plunger channel is defined in the lower housing and configured to receive the second fill plunger therein, and wherein the second plunger channel opens into the bottom of the manifold.

7. The food product forming machine of claim 6, wherein the first and second fill plungers are hydraulically driven between the retracted and extended positions.

8. The food product forming machine of claim 1, wherein the fill plunger is hydraulically driven between the retracted and extended positions.

9. The food product forming machine of claim 1, wherein the manifold inlet is positioned at a bottom of the manifold.

10. A food product forming machine, comprising:
a manifold including a manifold inlet and an outlet passageway;
a plunger channel positioned below the manifold, wherein the plunger channel opens into a bottom of the manifold and is in fluid communication with the manifold; and
a fill plunger positioned below the manifold, wherein the fill plunger is configured to reciprocate, at least partially within the plunger channel, between a retracted position and an extended position.

11. The food product forming machine of claim 10, wherein the plunger channel is a first plunger channel and the fill plunger is a first fill plunger, the food product forming machine further comprising
a second plunger channel positioned below the manifold, wherein the second plunger channel opens into the bottom of the manifold and is in fluid communication with the manifold, and
a second fill plunger positioned below the manifold, wherein the second fill plunger is configured to reciprocate, at least partially within the second plunger channel, between a retracted position and an extended position.

12. The food product forming machine of claim 11, wherein the first and second fill plungers move together in synchronization between the retracted and extended positions.

13. The food product forming machine of claim 11, wherein the first and second fill plungers are hydraulically driven between the retracted and extended positions.

14. The food product forming machine of claim 11, further comprising a lower housing positioned below the manifold, wherein the first and second plunger channels are defined in the lower housing.

15. The food product forming machine of claim 10, further comprising a lower housing positioned below the manifold, wherein the plunger channel is defined in the lower housing.

16. The food product forming machine of claim 10, wherein the fill plunger is hydraulically driven between the retracted and extended positions.

17. The food product forming machine of claim 10, wherein the manifold inlet is positioned at a bottom of the manifold.
